(19) United States
(12) Patent Application Publication
(10) Pub. No.: US 2008/0229215 A1
(43) Pub. Date: Sep. 18, 2008

(54) Interaction In A Virtual Social Environment

(76) Inventors: Samuel Pierce Baron, Santa Cruz, CA (US); Btzik George Cohen, Santa Cruz, CA (US)

Correspondence Address: Ashok Tankha, 36 Greenleigh Drive, Sewell, NJ, 08080, US

(21) Appl. No.: 12/048,236

(22) Filed: Mar. 14, 2008

Related U.S. Application Data
(60) Provisional application No. 60/894,890, filed on Mar. 14, 2007.

(51) Int. Cl. G06F 3/00

(52) U.S. Cl. 715/751

(57) ABSTRACT

Disclosed herein is a method and system for virtual interaction between multiple users of a virtual social environment. The method and system disclosed herein provides a virtual social environment for multiple users including a first user and a second user to socially interact. The virtual social environment enables the first user to host multiple multimedia in the virtual social environment. The step of hosting includes one of selecting prerecorded multimedia and adding multimedia content. The first user invites the second user for synchronous participation in the virtual social environment and consumption of multimedia in the virtual social environment. The interaction is based on multiple privileges assigned for the second user by the first user.

### CROSS REFERENCE TO RELATED APPLICATIONS

This application claims the benefit of the provisional patent application number U.S. 60/894890, titled “A method and system for social media consumption and interaction where participants in a multiple context environment can lead navigation manually or programmatically based on the collective input of those participants”, filed on 14 Mar. 2007 in the United States Patent and Trademark Office (U.S. PTO).

### BACKGROUND

This invention in general relates to online user interaction. More particularly, this invention relates to enabling users to socially interact in a virtual social environment.

Managers or employees of multinational companies, typically, employ means such as video conferencing or online chatting to share resources and to discuss official information with each other. For example, consider the vice president of a company, who is located in San Francisco, would like to have a meeting with the regional manager of the company, who is located in Amsterdam. The vice president of the company would like to share a video containing the annual budget of the xyz organization with the regional manager and also would like to interact simultaneously with the regional manager. In general, individuals across the globe may wish to share information simultaneously including voice, text, audio, or video. Therefore, there is a need for a virtual platform to share multiple data formats simultaneously in the Internet.

There is an unmet need for a method and system to enable virtual interaction between a plurality of users of a virtual social environment.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein, addresses the above stated need for a method and system to enable virtual interaction between a plurality of users of a virtual social environment.

The method and system disclosed herein provides a virtual social environment for multiple users including a first user and a second user to interact. The virtual social environment enables the first user to select from multiple virtual interaction sessions and to join a selected virtual interaction session. Further, the virtual social environment enables the first user to host multiple multimedia in the virtual social environment. The step of hosting includes one of selecting prerecorded multimedia and adding multimedia content. The first user invites the second user for synchronous participation in the virtual social environment. The virtual social environment enables the first user and the second user to interact in the virtual social environment.

The interaction is based on multiple privileges assigned for the second user by the first user. The privileges include allowing the second user to change user image, send invitation for others to join the session, search and add content, move the multimedia to a playlist, and modify said playlist. The interaction of the first user and the second user includes online activities comprising at least one of gaming, chatting, discussions, social networking, meetings, blogging, and sharing of the multimedia. The multimedia is one or more of graphical images, videos, slideshows, and audio content.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of virtual interaction between multiple users of a virtual social environment.

FIG. 2 illustrates a computer implemented system for virtual interaction between multiple users of a virtual social environment.

FIG. 3 exemplarily illustrates an overview of the participants in the virtual social environment.

FIG. 4 exemplarily illustrates the virtual social environment.

FIG. 5 exemplarily illustrates the basic operational flow of the virtual social environment.

FIG. 6 exemplarily illustrates a flow chart for related context content transfer.

FIG. 7 exemplarily illustrates the session and privacy settings used in the virtual social environment.

FIG. 8 exemplarily illustrates a structured view of the session settings.

FIG. 9 exemplarily illustrates the basic flow of content playback for the start of a new session or when a user joins after the session has started.

FIG. 10 exemplarily illustrates additional capabilities in the playlist.

FIG. 11 exemplarily illustrates the steps surrounding the actions where a user attempts to re-enter a session that had existed in the past.

FIG. 12 exemplarily illustrates a viewers list and display pictures properties.

FIG. 13 exemplarily illustrates the steps involved in providing a viewers list to the participants in the social session of the virtual social environment.

FIG. 14 exemplarily illustrates the steps in a real-time search and content programming aspect of the virtual social environment.

FIG. 15 exemplarily illustrates a content search for context transfer interface.

FIG. 16 exemplarily illustrates a communication initiator.

FIG. 17 exemplarily illustrates the user's machine.

FIG. 18 exemplarily illustrates a client machine.

FIG. 19 exemplarily illustrates the invitation initiation process which shows the options for sending invitations via instant messages.

FIG. 20 exemplarily illustrates a contact display and selection overview.

FIG. 21 exemplarily illustrates the display of a channel guide.

FIG. 22 exemplarily illustrates the basic components of a chat module.

FIG. 23 exemplarily illustrates how roles impact control states for content playback.

FIG. 24 exemplarily illustrates the current content clip.

FIG. 25 exemplarily illustrates a representation of a channel guide used.

FIG. 26 exemplarily illustrates a first step in communication initiation or starting point where an “initiate contact” button, link, or object is activated or clicked.

FIG. 27 exemplarily illustrates a permanent communications buddy for continued communication with users with instant messaging clients.

FIG. 28 exemplarily illustrates an overview of the system architecture of the virtual social environment.

### DETAILED DESCRIPTION OF THE INVENTION

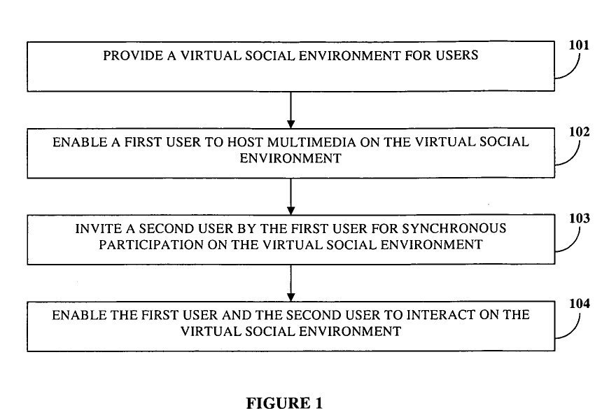

FIG. 1 illustrates a computer implemented method of virtual interaction between multiple users 301 of a virtual social environment 401. The method disclosed herein provides 101 the virtual social environment 401 for multiple users 301 including a first user 301a and a second user 301b to interact. The virtual social environment 401 enables the first user 301a to select from multiple virtual interaction sessions and to join a selected virtual interaction session. Further, the virtual social environment 401 enables 102 the first user 301a to host multiple multimedia contents in the virtual social environment 401. The step of hosting includes one of selecting prerecorded multimedia and adding multimedia content. The first user 301a invites 103 the second user 301b for synchronous participation in the virtual social environment 401. The virtual social environment 401 enables the first user 301a and the second user 301b to search and add multimedia in the virtual social environment 401. Furthermore, the virtual social environment 401 enables 104 the first user 301a and the second user 301b to socially interact in the virtual social environment 401.

The first user 301a creates a playlist in the virtual social environment 401. The playlist comprises a plurality of assorted multimedia. The interaction is based on multiple privileges assigned for the second user 301b by the first user 301a. The privileges include allowing the second user 301b to change user image, send invitation for others to join the session, search and add content, move the multimedia to a playlist, and modify said playlist. The interaction of the first user 301a and the second user 301b includes online activities comprising at least one of gaming, chatting, discussions, social networking, meetings, blogging, and sharing of the multimedia. The multimedia is one or more of graphical images, videos, slideshows, and audio content.

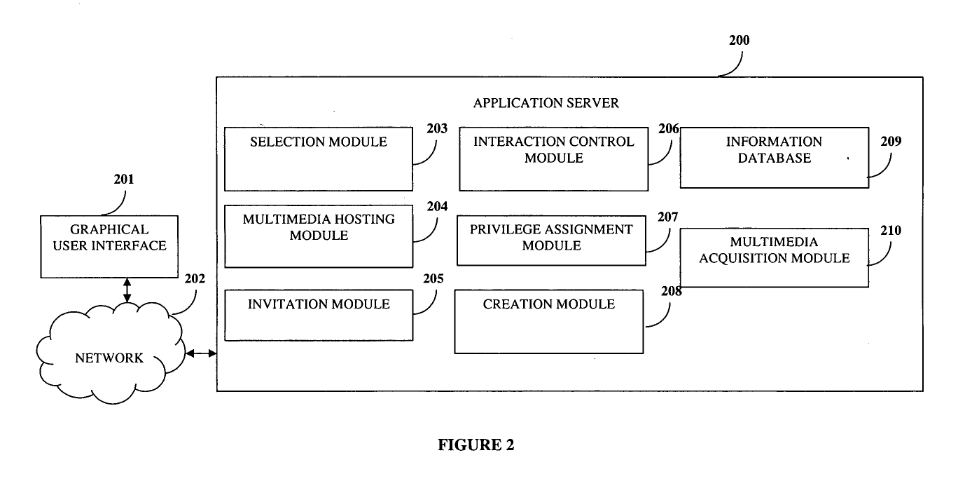

FIG. 2 illustrates a computer implemented system for virtual interaction between multiple users 301 of a virtual social environment 401. The system disclosed herein includes a graphical user interface 201 and an application server 200. The application server 200 hosts the virtual social environment 401. The graphical user interface 201 enables multiple users 301 including a first user 301a and a second user 301b to access the virtual social environment 401 via a network 202. The application server 200 comprises a selection module 203, a multimedia hosting module 204, an invitation module 205, an interaction control module 206, a privilege assignment module 207, a creation module 208, an information database 209, and a multimedia acquisition module 210.

The selection module 203 selects one or more of a plurality of multimedia provided in the virtual social environment 401. The multimedia acquisition module 210 adds multimedia content in the virtual social environment 401. The multimedia hosting module 204 enables the first user 301a to host a selected multimedia in the virtual social environment 401. The first user 301a uses the invitation module 205 to invite the second user 301b for synchronous participation in the virtual social environment 401. The interaction control module 206 enables the first user 301a and the second user 301b to interact in the virtual social environment 401. The privilege assignment module 207 is used for assigning privileges to the second user 301b by the first user 301a. The privileges include but not limited to allowing the second user 301b to change user image, send invitation for others to join the session, search and add content, move the multimedia to the playlist, and modify the playlist. The creation module 208 creates a playlist by the first user 301a in the virtual social environment 401. The information database 209 stores information of the first user 301a and the second user 301b and the multimedia.

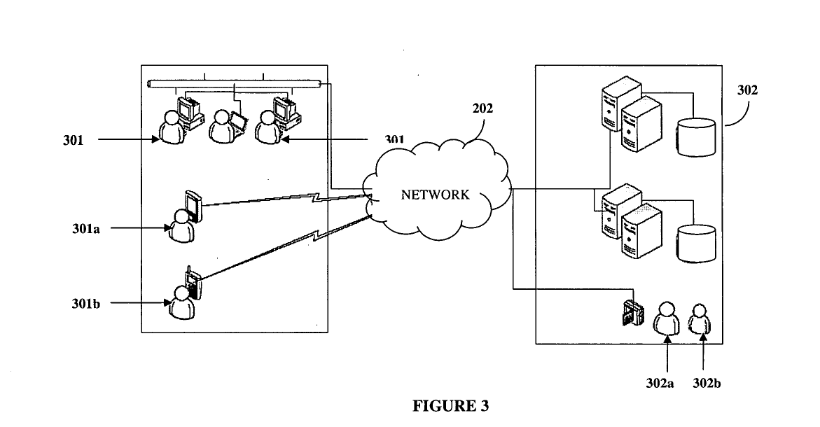

FIG. 3 exemplarily illustrates an overview of the participants in the virtual social environment 401. The participants include, but are not limited to a first user 301a, a second user 301b, publishers 302a, and distributors 302b, and a network 202 or internet. A class of users 301 participates in the consumption cycle of the invention, and includes users 301 whose primary functions are to consume media, collect and organize media for later presentation and consumption, direct media for future consumption, or purchase media for consumption or other related actions. Media may take the form of physical, electronic, or other forms of media where appropriate, that is, or contains, any representation that can be used for information or entertainment. The users 301 may consume media in a number of ways, including but not limited to computing devices such as computers, laptops, game systems or consoles, mobile phones, personal digital assistants, television, etc. where media may be experienced via senses of sight, sound, smell, feel, and taste. In an embodiment of the invention, media is consumed on a PC, laptop, or mobile device and displayed in a web browser or application dedicated to the presentation and consumption of media.

A class of users 301 and/or systems 302 participates in the publishing and distribution of the media consumed by 301. Media may be published and distributed by computing or other devices including, but not limited to, computing devices such as servers, computers, laptops, game systems or consoles, mobile phones, personal digital assistants, television systems, broadcast systems, live studio feeds, etc. 302 also includes the storage and storage distribution facilities necessary to store and supply the demand for consumed media.

The network 202 or inter-network connects users 301 directly or through a network of their computing and entertainment devices. In a simple embodiment of the invention, the Internet plays the role of 202.

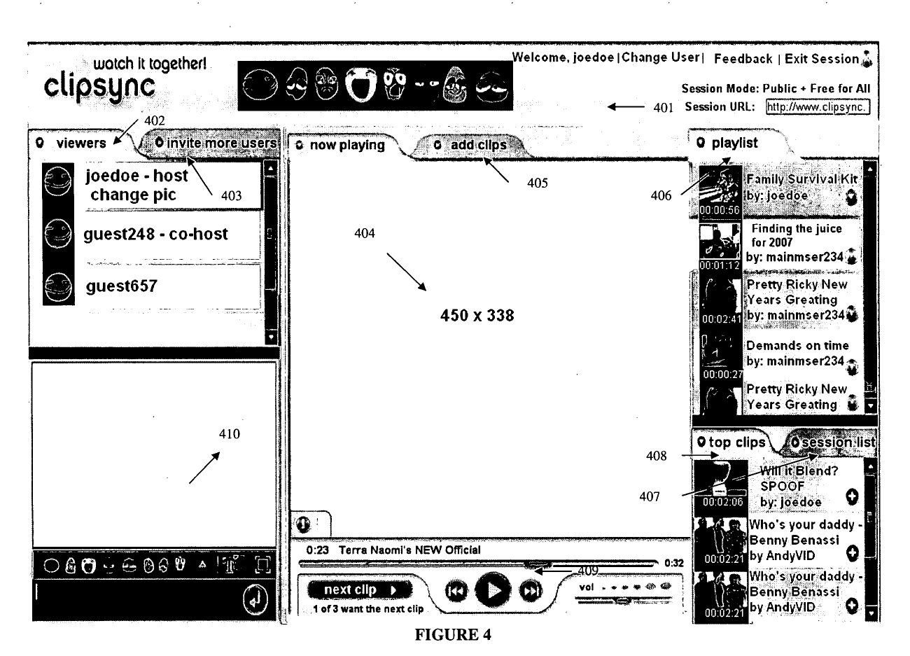

FIG. 4 exemplarily illustrates the virtual social environment 401. The virtual social environment 401 includes a viewers list 402, a first tab 403, a shared synchronous social playback area 404, a second tab 405, a playlist 406, a third tab 407, a top clips list 408, multiple controls 409, and a chat window 410. The viewers list 402 includes viewers who are active or passive participants in the context of the system. The first tab 403 initiates the invitation mechanism of the system which allows anyone to be invited to the current session through internal services and systems or through 3 party services and systems. The shared synchronous social playback area 404 marked “now playing” as illustrated in FIG. 4, allows content to be played in real-time synchronously for all the users 301, and where a user, called the “host”, can control playback to take such actions including, but not limited to, play, pause, fast-forward, rewind, skip to next content forward, rewind to beginning of current content, etc.

The second tab 405 allows the users 301 with permissions to add more clips to the current session and/or playlist, where content maybe added by any number of methods including but not limited to drag and drop, direct text entry, catalog selection or browsing, remote storage or remote transfer playlists, search in the system, search external system, etc. The playlist 406 for the current session contains content which is ordered for future playback after the content in the shared synchronous playback area has reached its end or is terminated. The third tab 407 sources and displays a session list, where sessions include, but are not limited to real-time synchronous playback of content with one or more users 301 participating actively or passively. The users 301 may transfer their attendance from one session to another by clicking on any of the sessions listed. A sessions tab may be provided for changing the virtual sessions in the virtual social environment 401.

The top clips list 408 is displayed when the tab “top clips” is in focus or clicked to become in focus. By default, the top clips tab and list are in focus. The top clips list represents one of several lists of content that may be presented by default, and may conceivably be replaced by top content from a dedicated source, from a specific network, from all known networks, or subsets thereof. The top clips tab may be used as a source for content in the playlist 406, where content may be moved to 406 via drag-and-drop, clicking a “+” sign next to the content description, or other standard additive mechanism. The multiple controls 409 enables the users 301 to play, pause, fast-forward, rewind, skip to next content forward, rewind to beginning of current content, etc. The multiple control 409 also includes a “next clip” or content advance request which, while placed in the control area of the shared synchronous social playback area 404, affects what is rendered in the viewers list 402, the content played in the shared synchronous social playback area 404, and the playlist 406. The chat window 410 offers a social interaction context for the users 301 who are logged in and the users 301 who are not logged in. A user can click on the icons or emoticons in this area and initiate visual expression, audio expression, or other forms of personal expression in the chat window.

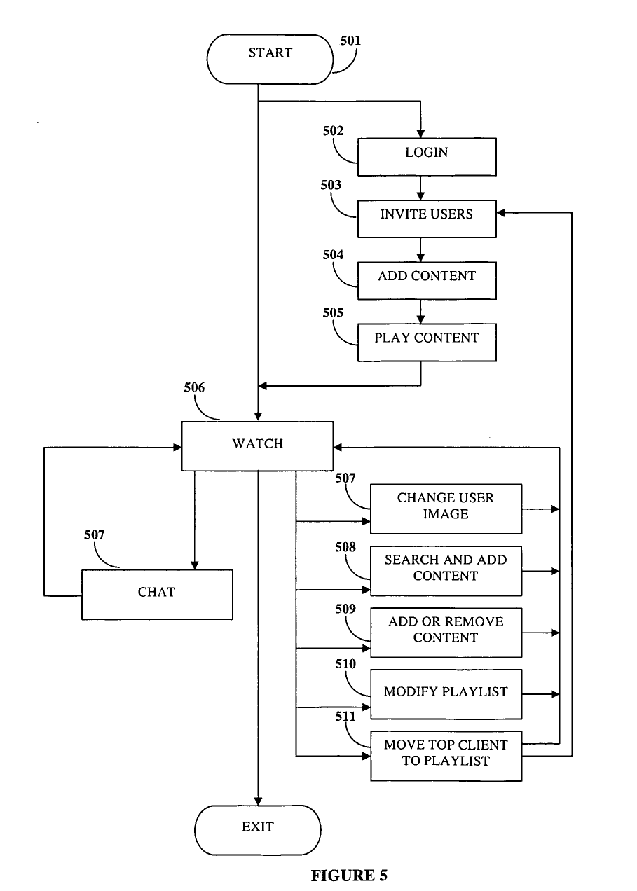

FIG. 5 exemplarily illustrates the basic operational flow of the virtual social environment 401. A user starts 501 the process by launching the virtual social environment 401, which may be implemented in a browser, in a browser plug-in, in a web or browser application, or as a stand alone application on a desktop or portable computing device. In one embodiment, the virtual social environment 401 operates as a web application running in a browser using Flash by Adobe®, however the choice of Flash is not meant to limit or suggest limits where the invention may be implemented.

The virtual social environment 401 is launched 501, which may be automatically launched when a web page is opened. The virtual social environment 401 may be memory resident or loaded upon web page rendering. A user creates an account and logs 502 into the account. The users 301 invite 503 other users 301 to try the service at any time. The invitation allows a user to invite other users 301 to join him or her immediately in the virtual interaction session that the user is participating in. The invitation is a real-time invitation intended to instantly notify others that there is an event going on at the current moment. The event is a virtual interaction session and may comprise multiple interacting simultaneous social contexts.

The users 301 add 504 multimedia, where multimedia may include, but is not limited to, video clips, audio or music clips, or other content not specifically audio or video clips. Contents can be added directly by drag and drop, universal resource locator (URL) or hypertext transfer protocol (HTTP) entry, plug-in, search, or other methods. The users 301 play 505 content, where any content playable by the system or able to be played by other systems launched by the system, whereby the system plays selected or queued content. The users 301 may utilize the multimedia and watch 506, play or listen to the multimedia without login. The users 301 may chat 507 in the virtual social environment 401. The chat may be accomplished via text, avatar, or other chat function, where all the users 301 in the current session can participate based on user permissions and session context. Further, additional advanced interactions other than chat may be provided for the users 301 after login. These advanced interactions consist of any number of social interactions beyond chat, and include, but are not limited to changing 507 the user's image or picture, searching and adding 508 content to the session or session playlist, add or remove 509 content from the session playlist, modify 510 or reorder the playlist, or move top client to playlist 511.

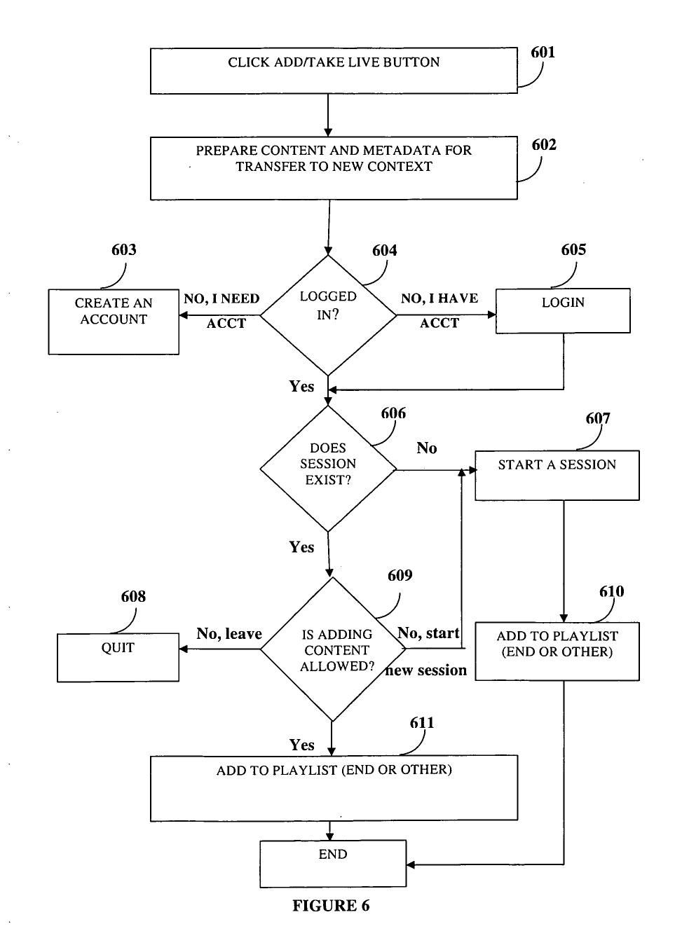

FIG. 6 exemplarily illustrates a flow chart for related context content transfer. The content can be transferred from a trusted context to the context of the virtual social environment 401 session. The transfer of content from one context to another may apply to untrusted or unrelated contexts; however, the embodiment describes a trusted shared login for the diagram. The flow chart comprises initiation of the content context transfer, where a “add” or “take live” 601 button, link, or other representation designed for the purpose of content context transfer is clicked or activated. The flow chart comprises preparation and/or collection 602 of information for the transfer from the current context to the virtual social environment 401. In a web-based implementation, the information may be in the form of an encrypted or unencrypted URL, an HTTP POST, a database call to a stored procedure, or other action designed to enable the transfer of the user and content to the invention. If the user has a current logged 604 in status of a virtual social interaction session, the virtual social environment 401 directs the system processing of the user accordingly.

The user creates an account 603 if the user does not have one. In this embodiment, a user session is required to exist for the content context transfer. If the user creates an account, the user may then use the content to initiate a new session with the transferred content. The user logs in 605 if the user has an account. The user login does not guarantee that a session exists where the user may transfer content, however, the login action can assist in determining if there is a context to which the content may be transferred. If the user with an account has an active session the content may be transferred. If the user does not have an existing session, the user may start 607 a new session with the content. The content may be transferred to the users 301 new session. If the user does have an existing session 606, the system checks if content introduction is allowed 609, and if so, by which users 301, or what permissions are required. The users' 301 past session participation does not guarantee that the permissions and capabilities of the session are unchanged. Session participants, hosts, and other factors may account for changes in permissions, rules, and other restrictions for the session. If the content is not transferable, the user may elect to start a new session. If the user is not allowed to add content and wishes to leave, then the user may quit 608 the virtual social environment 401.

If the session the user is attempting to enter allows content introduction via the context transfer, then the user adds 610 the content to the playlist. The transferred content is added 611 to the end of the playlist by default. However, other content management rules may come into play where content placement is determined by rules of by participants in the session. The content has been transferred to the new context.

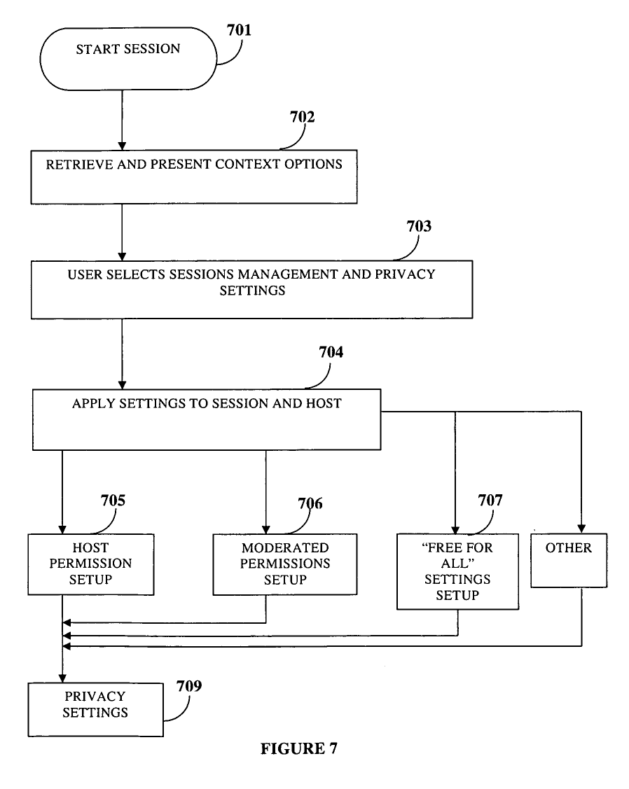

FIG. 7 exemplarily illustrates the session and privacy settings used in the virtual social environment 401. In the virtual social environment 401 the privacy settings are established upon session start 701 by the user who starts the session, or the host. Default settings may apply based on several factors, including, but not limited to, system settings, time of day, geographical location, system event or activities, other worldly events, sponsorship, participants, user demographics, and more. The sessions may be started in any number of ways; however, the session and privacy settings process must always be set, either in the methods shown, by default, or via other methods which establish a minimum context for the interactions for users 301 in the virtual social environment 401 session. Further the settings and privacy options are retrieved and presented 702. This may be accomplished via a flat file, database, or other configuration mechanism, where the data describing the session and privacy setting available may be encrypted or not encrypted.

The user starting the session selects 703 the scope of moderation control and the privacy of the session. The user then applies the settings to the session and host. The session is assigned the settings and constraints, and the user's record is updated with session and settings info which may apply 704 to future reputation or other historical management. Applying settings include host permission setup 705, moderated permission setup 706, “free for all” settings setup 707, and other permissions in the virtual social environment 401. In the host permission setup 705, the user is the host, and is the sole session participant who can invite users 301, modify or update the playlist, control synchronized content playback, etc. The host may change the settings at a later time if desired. In the moderated permission setup 706, the host may allow others to co-host with the host, where others can add content to the playlist, and others can jointly control playback of content. In the “free for all” settings setup 707 anyone can add or modify the playlist, control content playback, invite users 301, etc. Each session settings are set to free for all when the host leaves the session. The other permissions include future settings and permission including, but not limited to, randomized control, game based control, or other incentive managed control conditions where users 301 or groups may interact with content and/or each other in sessions.

In the step of setting 709 of privacy settings once the session control has been established, session privacy may be set to hide detailed information about the session and thereby only show that a session exists. A private session cannot be joined by others unless the user has an invitation, a link that acts as an invitation, and a session password or other authentication, if necessary, to join the private session. A public session allows anyone to join. For privacy and session settings, the above describe only a subset of possibilities, where the implementation set can include two classes, the class of the session and privacy settings as described above in the implementation of the invention, and the class of settings not described, but can also be implemented as entirely new settings or variations or combinations of the first class.

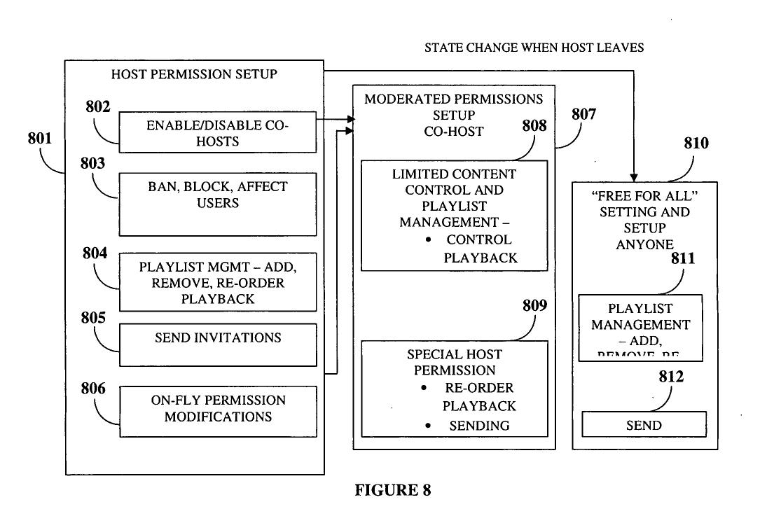

FIG. 8 exemplarily illustrates a structured view of the session settings. In the session settings a permission setting is a super-set of capabilities for a participant in a session, where a participant may be a host, co-host, or someone not a host or not a co-host. 410 shows the host permission session settings setup 705. In this mode logical actions can be taken by the host of the session. In this configuration, the host can effect a number of actions including but not limited to 411 enabling or disabling co-hosts, 412 banning, blocking, or imposing other constraints on session users 301, 413 playlist management such as add, remove, or re-order playlist content, 414 send invitations to the session, or 415 real-time permission updates for long or short term effect. 411 represents the ability to change session settings to enable or co-hosts, by finite permission changes or by changing the session setting to 420 moderated permissions.

412 represents the ability to ban, block, or otherwise affect users 301 in the current session, preventing them from participating in the session, taking actions in the session, setting reputation information, and/or other actions. Other actions include but are not limited to mute, limiting chat ability, limiting interaction ability, limiting search ability, limiting playlist modification ability, limiting information display, etc. 413 represents the ability to manage and affect the content playlist for the current session. This includes but is not limited to the ability to add content through any number of processes, delete content from the playlist, transfer content or playlists, or re-order playlists. 414 represents the ability to send invitations to others who may receive the invitations to join the current session. 415 represents the ability to dynamically assign or remove permissions to users 301 in a session independently of their status as co-host of a session.

420 represents moderated permission setup, where the default is to allow co-hosts limited capability including limited 422 playlist management and 424 special host permissions. 422 represents limited playlist management abilities available to co-hosts. These features include, but are not limited to adding clips to the current session's playlist, and removing the content that they added or controlling (start, pause, stop) playback of the content that the co-host submitted. 424 represents special host-like permissions that may be available, based on host permissions and other session or system settings. These special permissions include re-ordering playback and issuing invitations. 430 represents the session setting labeled as “free for all”, where all session participants are free to “do anything” in the session. All functions are available to everyone in the session, including all capabilities listed in 410, 420, and those that will be added for future moderation and usability implementations.

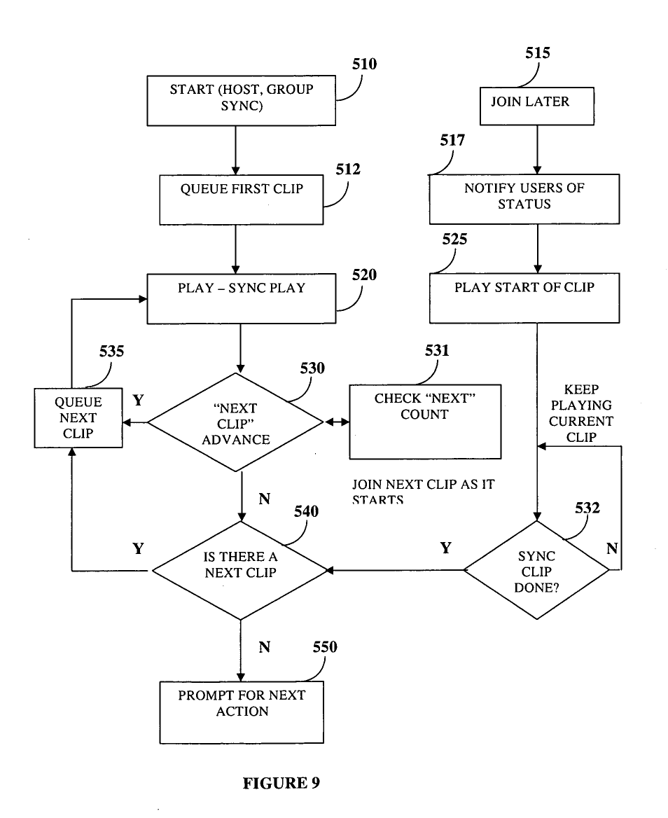

FIG. 9 exemplarily illustrates the basic flow of content playback for the start of a new session or when a user joins after the session has started. 510 represents the start of a session where content may be added for participants to consume, listen to, or view. 512 represents the step where content is queued up for playing in the current session. Content is queued in the playlist, where content may be introduced into the playlist from any number of sources, including but not limited to search, drag and drop, “take live” type buttons or links, added from recommendations, etc. 515 represents a user who joins a session that is already in progress, with content already playing. 517 is the step where the user joining the session in progress is notified that the session is already in progress and content playback has started. The user will be notified of what will happen until the next opportunity to synchronize with the group. The default setting is to play the same content that others in the session are viewing, but starting at the beginning of the content, and taking an action at a later point when 532 is reached and the current content clip is terminated. In a preferred embodiment, the system would fast forward the content to enable the user to participate in synchronized content consumption, however the notification message 517 would instruct the user to wait until synchronization was ready.

520 represents the playback of content from the playlist to the participants of the session, where playback is led by the host or co-host. 525 is the default action mentioned in 517, where the current content in 520 is played from the start to participants who joined the session after the host and co-host started playing the content in the current session. The users 301 view content while in a pending state to join the current session. 530 represents the step where the current session led by the host or co-host advances to the next content item in the playlist. The advancement to the next content item can be automatic, which occurs when the current content items ends, host or co-host driven, where the host or co-host initiate playback of the next content items, or semi-automatic, where participants in the session click a “next clip” button or link to self report desire to advance to the next clip, and where a minimum threshold of users 301 clicking “next clip” will invoke the advancement to the next content item in the playlist. The “next clip” button or link can operate as stated independent of the actual name choice, however the group social navigation by minimum threshold and queued playlist functions the same. The “next clip” advancement mechanism is only available when there is additional content in the playlist. If there is not other content item in the playlist, then the user clicking “next clip” is instructed to add content, or, depending on settings and configuration, content may be randomly inserted, programmatically inserted, or automatically transferred from programming or a top content list.

531 represents the logical check of the number of users 301 requesting the “next clip” function against the rules or thresholds which trigger the advancement to the next content item in the playlist. If the conditions are met, the information is passed to 530, which triggers the advancement to the next content item. 532 represents a watch dog, polling, or other mechanism which detects if and when a content item in the current session has reached a termination point and a new content item playback will begin. Once detected, the users 301 who are in a pending state are synchronized with the next content item playback. The users 301 out of sync 515 will also be brought into sync if content playback head is moved to, paused at, or started at a point which users 301 out of sync 515 have buffered. 535 represents the next content item to be played in the current session which is pulled from the playlist and queued for all participants in the current session and all users 301 who have been in a pending state while the content in the current session was being played. 540 represents the step where the current content has finished playback or a “next clip” action has been triggered, requiring advancement to the next content item if one exists. If a content item exists in the playlist, it is queued 535. If no next clip is detected or available for playback, users 301 in the current session and users 301 joining the current session from the pending state are all instructed to take further action. Further action includes but is not limited to instructions to add content via search, top lists, “take live”, etc., or, depending on settings and configuration, allow or enable content to be randomly inserted, programmatically inserted, or automatically transferred from programming or a top content list.

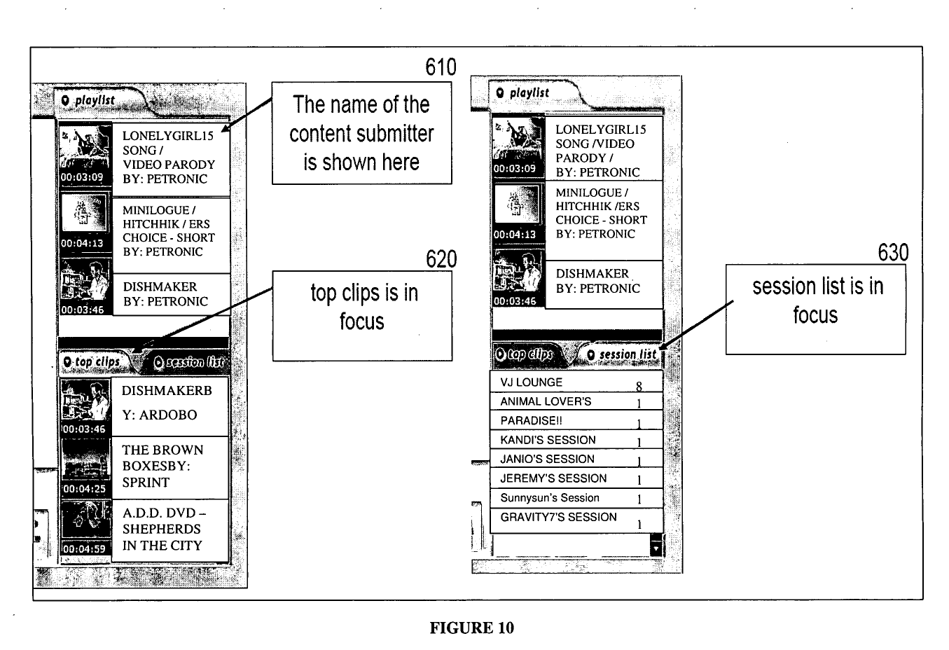

FIG. 10 exemplarily illustrates additional capabilities in the playlist. The additional capabilities include appending content contribution information to the playlist content metadata and rendering for display in the playlist. 600 also shows additional information for the session list. 610 shows additional detail about content in the playlist. While a thumbnail, title and duration are shown, that information is metadata of the content that was acquired when the content was searched or fetched for potential use in the system. Once the content has been placed into a playlist, the content metadata is supplemented by the name of the user who submitted the content. 620 shows the top clips in focus in the system, where top clips are a broad category of content provided to make content easily available for placement into the playlist. The top clips section may include, but is not limited to, top content from within the system, top clips from external systems, clips rank ordered for views, by voting, by interaction, by reputation, by algorithmic inclusion, by commercial value, by advertising value, and more.

630 shows the session list in focus, where the session list may be a local or distributed list of sessions known to the system. The sessions shown may include all, a fraction, or a filtered subset of sessions, and the list may be dependent on the permissions of the user and/or context of the actual session. The session list includes the list of all sessions viewable to the user and includes a visual (numerical or other) indicator of the number of participants in the listed session.

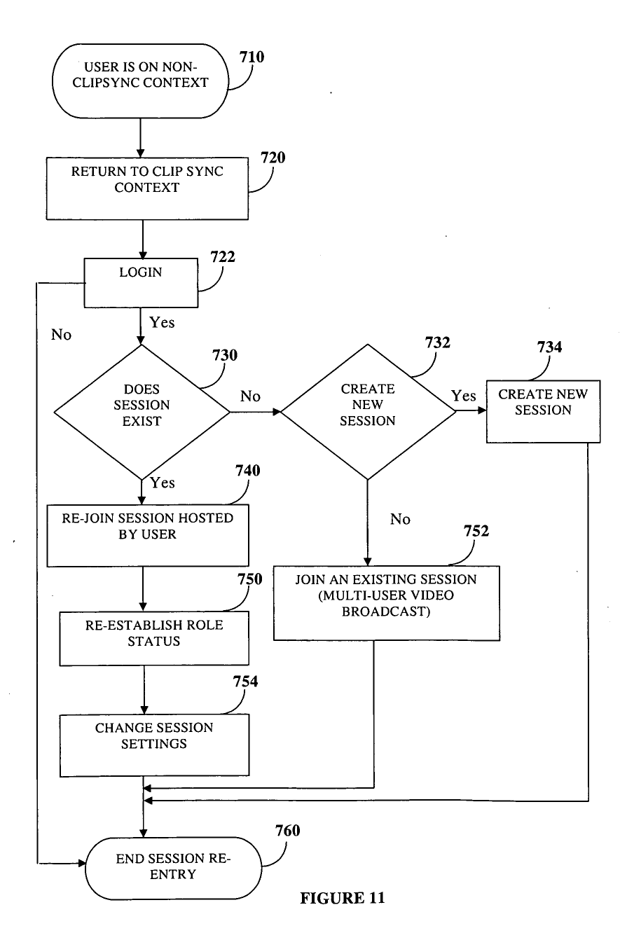

FIG. 11 exemplarily illustrates the steps surrounding the actions where a user attempts to re-enter a session that had existed in the past. 710 represents the starting point where a user is not in the context of a session. The user may be in any number of non-session contexts, including, but not limited to on another web page, using another application, starting or restarting a browser, etc. 720 represents the step where a user goes to a clipsync application, clipsync.com, or other clipsync context where the invention operates. 722 represents the step where the system checks if the user is logged in. The user may have a valid and current login stored in a cookie or other marker locally or on a server of the system. The user must login or use a valid login state from a previous session to be able to re-enter a previous session. If the user does not login, they exit 760. 730 checks if a valid session exists, and a “re-enter session” link, button, or action is enabled and displayed to the user. If a valid current session is no detected, the user is prompted to create a new session 732. 732 represents the step where the user is not re-entering an existing session, but instead can create a new session 734 or join another session not the previous session the user was in 752.

734 represents the action of creating a new session, where the normal session creation and permission settings apply. Creating a new session takes the user out of this flow to 760. 740 represents the user joining his/her previous session, where the user and associated user data are brought back to the session. Since the session is on-going, the content, chat, or other interactions continue as the user is reintroduced into the session. 750 represents the re-establishment of role status for the user. If the user was a host or co-host, he/she is automatically re-assigned the host or co-host status. While the role status is re-established, the permissions may not be reset to those when the user last participated.

754 represents the optional changing of session settings. The system can be set to automatically re-establish session settings and permissions to the configuration when the user last participated if he/she was a host, however, by default, only the role status 750 is reset. The host or co-host may re-instate permissions or settings as they see fit in this step and as allowed by system settings and/or rule. 760 represents an exit point.

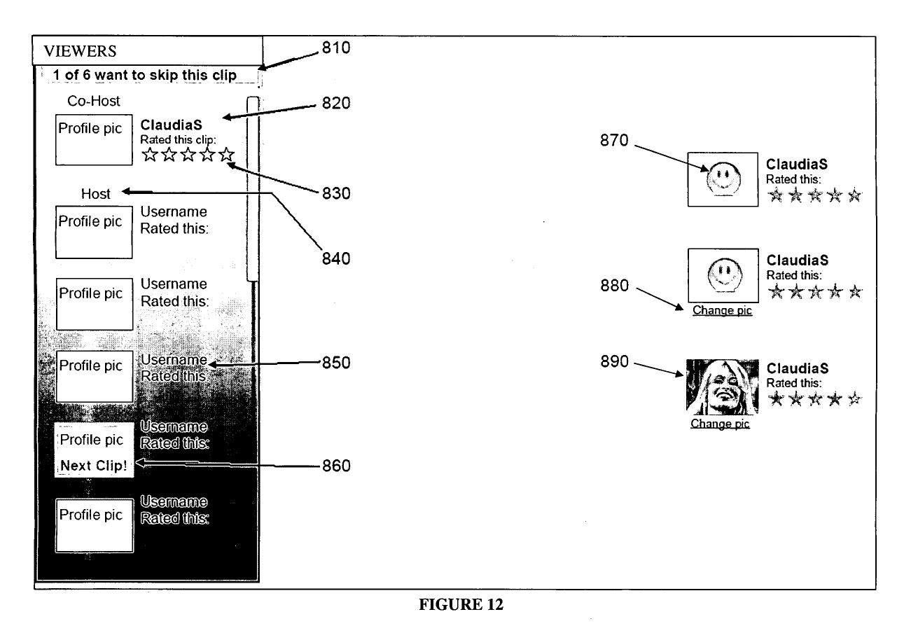

FIG. 12 exemplarily illustrates a viewers list and display pictures properties. 810 shows a social navigation message. This message shows number of users 301 with “Next Clip Please” pressed. If no users 301 have clicked “next clip please”, the message is hidden. Once a user has pressed “Next Clip Please”, the “Next Clip!” message is rendered in the viewers list and serves as a notification to the host and/or co-host that the user would like to advance to another clip. When enough users 301 have clicked “Next Clip Please” and show “Next Clip” in the viewer list, the clip is advanced as described in 960 and 965. 820 which user is controlling the content playback. The current host or co-host is at top of list, highlighted, marked host or Co-Host. In Free for All mode, Host tops list and all others are marked Co-Host. No driver, or user in control of playback, is designated. 830 shows the ratings that may be displayed in the viewers list. The rating is shown as “Not Yet Rated”, “unrated”, or “Rate this” until the user enters a rating in this session.

840 shows how the session creator, or host, is identified. The Host is marked Host, and when not controlling playback of the current content, the host is second in list. Otherwise, the host appears at the top of the list. 850 shows how participants or viewers are represented in the viewers list. After the current co-host or Host controlling playback and the host, if not controlling playback, the remaining viewers are in alphabetical order by username. The users 301 do not have rollover state. 860 shows how users 301 are represented when they have clicked “Next clip please”. User with “Next Clip Please” pressed has their display picture highlighted and marked “Next Clip!” Once a user has pressed “Next Clip Please”, the “Next Clip!” message is rendered in the viewers list and serves as a notification to the host and/or co-host that the user would like to advance to another clip. When enough users 301 have clicked “Next Clip Please” and show “Next Clip” in the viewer list, the clip is advanced as described in 960 and 965.

870 shows how users 301 are represented with a default or selected display picture. Every user in the Viewers list has a display picture, where the display picture can be a system default, randomly assigned from a default pool or group of pictures, a personally uploaded picture, an avatar, video, live video feed, or a sponsored or branded picture. If a session, group of sessions, or otherwise negotiated sponsorship dictates that a display picture or several display pictures are used, the users 301 in the aforementioned sessions will have the display pictures associated with the brand or sponsor, regardless of their customized choice. The application of a session specific display picture is determined by a context manager in the system. 880 shows a picture customization link for the current user. Each user sees a link beneath their user picture and only their own display picture in the viewers list. Clicking the link displays a standard file chooser dialog that lets the user browse image files on their computer, a list of other defaults that are allowed for that session, or an image chooser for sponsored or branded images where appropriate. The “change picture” options are stored and managed by the session's context manager.

890 shows an example change of display picture. After the new picture is selected, it appears in the viewers list for that user. The change is immediately visible to all the users 301 in the session. While customized display pictures can come from formats including, but not limited to jpeg, gif, bitmap, etc, the actual images can be pre-filtered via image recognition technology to prevent certain images from appearing or being used, or images can be “flagged” as inappropriate.

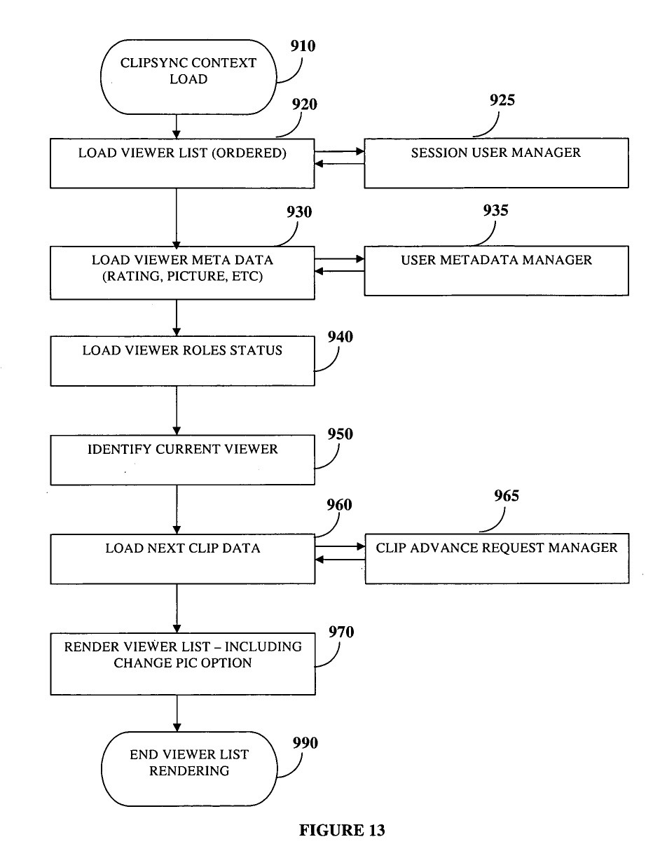

FIG. 13 exemplarily illustrates the steps involved in providing a viewers list to the participants in the social session of the virtual social environment 401. 910 represents the starting point where a clipsync session begins and the major contexts are requested for rendering. 920 represents the request to load the viewer list, where the viewer list is the list of all participants in the social context of the invention in a single session, where there may be multiple sessions, each with a viewers list. 925 represents the user manager of the invention which manages the users 301 and their participation in unique sessions. The user manager returns the user list for the current session. The session user manager is a logical function that can be implemented alone or combined with other modules and contexts such as chat and playback.

930 represents the metadata load request to load metadata for each user returned in 920, including data including but not limited to name, picture, rating for content in current session, etc. 935 represents the user metadata manager which manages data specific to the users 301 in the system. The user metadata manager returns the requested data to 930 including only user data relevant to the current session and content. Additional information is available to and managed by 935, however in this context only the current session data for the viewer is provided. The user metadata manager is a logical function that can be implemented alone or combined with other modules. 940 represents the step where the role (host, co-host, etc) is provided to the viewer for proper identification when rendering. The roles information is stored in the session database.

950 represents the step where the login information is matched to the user list to identify the user when the viewer list is rendered. 960 represents the step where social navigation data for content in the current session is requested for rendering. 965 represents a clip advance request manager which collects, tracks, and manages data related to socially driven content advancement for each session or individually driven content advancement by the host or co-host. Each user that has clicked the “next clip” button, link, or indicator, has a flag that is used to visually indicate the request and is used in application logic to advance the content to the next item. The clip advance request manager is a logical function that can be implemented alone or combined with other modules.

970 represents the rendering step, where user, role, navigation, and associated metadata are rendered into the viewer list for the current session. 980 represents the completion of generating the viewers list.

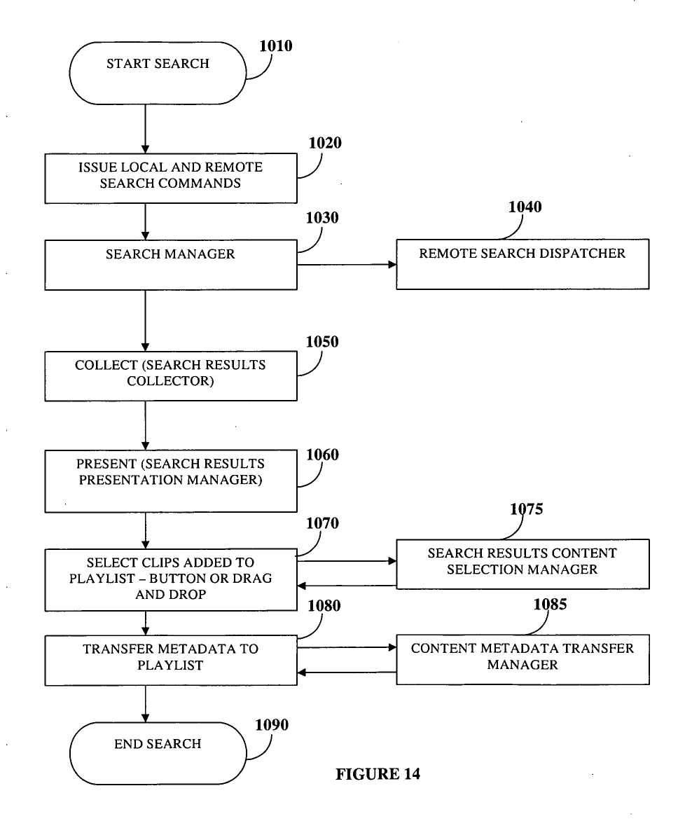

FIG. 14 exemplarily illustrates the steps in a real-time search and content programming aspect of the virtual social environment 401. 1010 represents the start of the search for content process, where a user clicks on a link, button, form, or other object which submits data for a search, where search terms were input by the user. 1020 represents a command handler to dispatch to local system and/or remote systems, including third party systems, which recognizes and parameterizes the content search. 1030 represents the search manager which manages search through local systems and manages the search of remote contents sites using 1040 remote search dispatcher. 1040 receives the search command parameters, including but not limited to search sites/engines, search relevance, number of results, and other factors, and interacts with remote search sites and search engines via API, site scraping, or other mechanisms to request the search results around the terms submitted in 1010. 1040 can also access libraries of video and saved playlists for specific users 301, a group of users 301, or all users 301 within clipsync or clipsync partner context. 1050 represents the search results collector, which retrieves or receives and processes results from various sources, including data including but not limited to thumbnails, tags, descriptions, metadata, etc.

1060 represents the search results presentation manager which presents the search results in any number of forms, by popularity, by source, etc, as determined by confirmation or customization, or other layout settings. 1070 represents the selection of content returned from the search to be made available for selection and insertion into the playlist. Content selection is controlled by 1075 search results content selection manager. 1075 search results content selection manager enables and controls which content may be selected and presented for selection for placement for the playlist. It may further filter the selectable content via any number of filtering criteria including session context, child safety, age minimums, and content ratings, etc.

1080 represents the step where content is transferred from the search interface into the playlist for future playback. The transfer mechanism may include but not be limited to drag-and-drop, one-button “add to playlist”, multi-selection mechanisms, and other standard transfer mechanisms, and is managed by 1085 content metadata transfer manager. 1085 content metadata transfer manager represents a smart mechanism that allows not only actual content transfer from one storage location to another, but also the transfer of unencrypted or encrypted links or pointers to the actual content which may be played back later. 1085 manages the metadata for each content item, uniquely identifies the content or content link if possible, and allows the playlist to render a representation of the content item in the playlist. 1090 represents the end of the real-time search and content program steps.

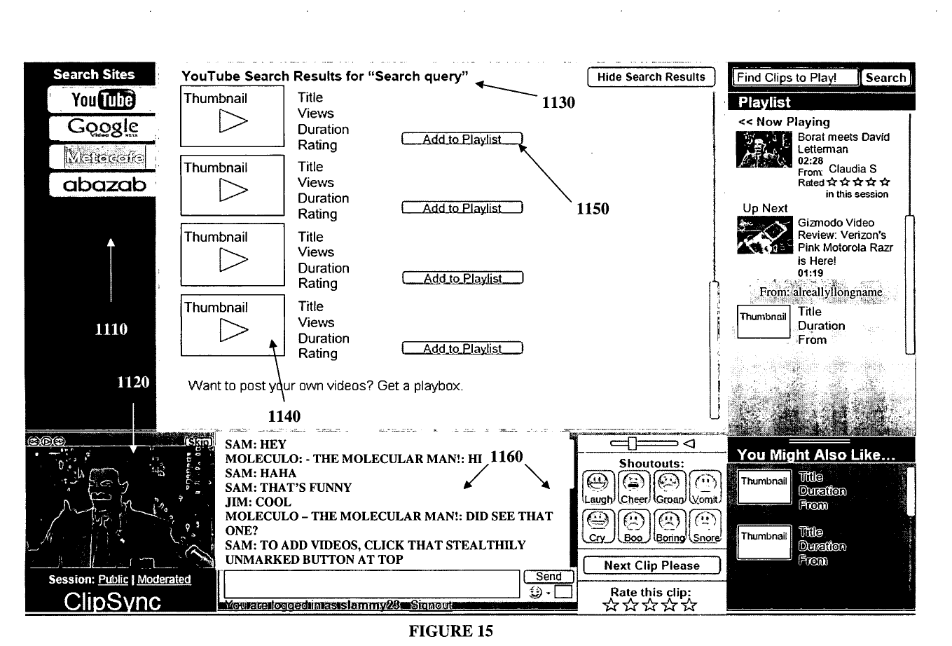

FIG. 15 exemplarily illustrates a content search for context transfer interface. When search results are being retrieved (during both query creation and results presentation), the content from the current session continues playing, however, audio is muted. When search process is paused or ends, audio is unmated. 1110 Shows an expandable search source list, where search engines or content sources to be searched are listed. Search engines and other content sources may be added and will automatically appear in the list as they are made available to the system. The search engines and content sources are searched using any available APIs designed for the search purpose, or they may be searched via other means including, but not limited to web site page scraping, RSS feeds, 3^{rd} party published lists, and more.

1120 shows the content from the main playback window, that continues to play while the search occurs. 1120 shows a reduced size playback for the user conducting the search. The users 301 who are not searching continue to see the normal playback window. 1130 shows the search query results display, where this example shows results from video content site “YouTube”. Results may be presented from other searches of the sites listed in 1110 when the user clicks the name of site in 1110. 1140 shows a representation of the content arrangement in the search results, where search results are shown including thumbnails for each content item returned together with title, popularity (views), duration of the content, and rating if any or all of that information is available for the content item. 1150 Shows a “add to playlist” button, link, or other object designed to enable the transfer of search results to the playlist. If the playlist is locked or the session has a restrictive session setting such as host control only, all but host see these buttons disabled.

1160 shows a chat window where the user conducting the search can continue to view the chat activity that may be occurring while the user searches. Combined with 1120, 1160 allows the user to stay current with multiple contexts including the context of the content playback and the chat or communications context of the session while he/she operates a search context for future content inclusion for the session. 1160 also includes a presentation of a rating system where the content in playback in the current session may be rated by participants subject to permissions and settings of the session. 1160 is further explained in 1800 and related descriptions. 1200 shows the message based Social Context Transfer part of the system comprising an internal and external system messaging based communication and context transfer and which uses, in the example, instant messaging (IM), but may use other types of messaging mechanisms and protocols. This mechanism is described in the primary embodiment to facilitate messaging flows as described in 2200, including, but not limited to: current session invitations, non-session invitations, general broadcast messages, personal messages, update and reminder messages, and general user-to-user communication. 1200 is intended to allow the users 301 in the context of the current session to communicate with the users 301 in a context not the current session and, via the communications of 1200, enables the users 301 in a context not the current session to join the current session, future sessions or otherwise participate in the system.

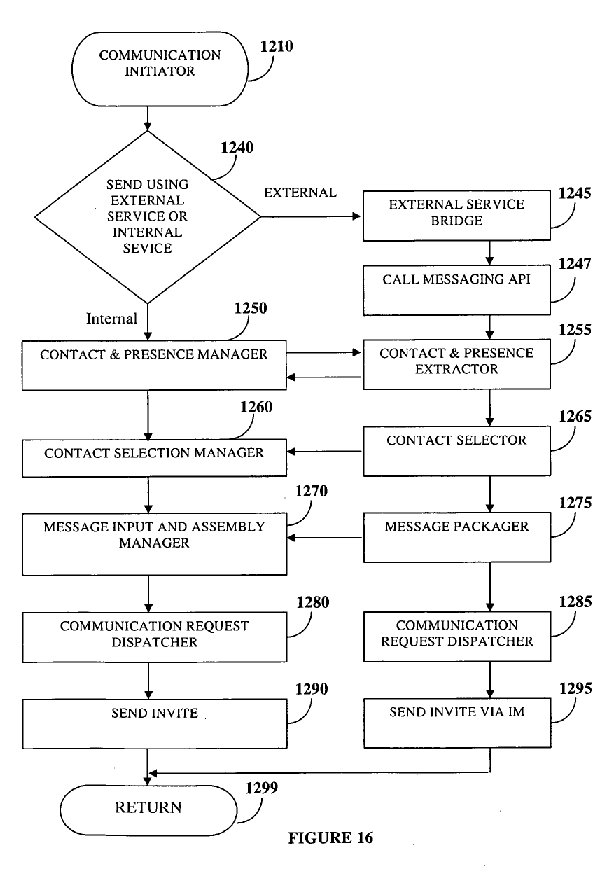

FIG. 16 exemplarily illustrates a communication initiator. The communication initiator takes the current communications context from 2200 and prepares for further application processing based on that context. In a communication action for the current session, a valid session ID is checked, and if accepted, begins by preparing applications and parameters for either using internal systems or external 3^{rd} party systems for the communication, where the communication may be sent using both internal and external systems in series or in parallel. For communications not related to an ongoing session, such as a an information broadcast, an invitation to try the service, or an invitation to a future session, no valid session ID is required, but may be used if the future session ID is known. For automatic, programmatic, or manually scheduled updates or reminders, the communication initiator activates based on an event or trigger and processes the communication based on rules associated with the automatic, programmatic, or manually scheduled update or reminder using the steps 1240 and following.

1240 determines is either internal, external, or both internal and internal message distribution systems will be needed, and dispatches the appropriate parameters to the internal, external, or both systems which commence the communication process. 1245 represents an external service bridge, a part of the invention, which provides management of the interaction with one or more 3^{rd} party systems through several functional components. 1247 represents an API interface or adapter in the system which calls the API of the 3^{rd} party system, if one exists, or calls an adapter of another source, if one exists, to commence the communication mechanism. The adapter of another source may be a module of the system purposed for extracting information from the 3^{rd} party system, a module provided by an external service for the same purpose, or another adapter, SDK, dll, or other product designed and developed for the same purpose.

1250 represents a contact and presence manager that manages contact and presence information for communications from the system and handles contact and presence information from 3^{rd} party systems passed from 1255 contact and presence extractor. 1255 represents a contact and presence extractor which requests and receives or programmatically extracts contact and presence information from a 3^{rd} party system and transforms it to a readable or parse able list, typically through an API 1247, but may use other modules created for that purpose. 1260 represents a contact selection manager that manages the selection, de-selection, of individual or groups of individuals for communication to participate in the system. 1260 can track internal selection processes and history as well as process contacts selected from 1265 contact selector.

1265 represents a contact selector for selecting contacts returned from contact and presence extractor 1255 for the 3^{rd} party site. The contact selector takes the list from 1255, presents the contacts and their online status, and allows the selection of none, one, or more contacts to communicate with in the 3^{rd} party system. 1265 then sends the selected contact list to 1260 for tracking, saving, historical tracking, and other management and to 1275 for creating a message package for delivery to the 3^{rd} party users 301. 1270 represents a message input and assembly manager that manages the historical communications sent, the default messages, the message customizations, and message packages created and used for all communications run through the system. Depending on the type of communications, 1270 can allow fixed single or subsets of messages to be used for the communication or allow for free from message creation or edits of the pre-existing messages. 1270 manages the internal system messages that are sent to 1280 for delivery to the users 301 being invited to the system and saves, integrates, and maintains a historical record of the message packages created and used for 3^{rd} party invitations in 1275.

1275 represents a message packager where messages sent to 3^{rd} party systems for invitations are created and/or customized for delivery to invitees. 1275 can use historical or default messages from 1270, and, if enabled, allow customization of messages for the invitation. Unique messages created in 1275 are then stored and identified with the context of the invitation with 1270, where the message may be used as a template later. 1280 represents an invitation request dispatcher which takes completed messages from 1270 and contacts from 1260 and queues them for sending for the internal system contacts.

1285 represents an invitation request dispatcher which takes completed messages from 1275 and contacts from 1265 and queues them for sending for to 3^{rd} party system contacts. The contact list and messages are sent via API of the 3^{rd} party system if one exists or call to an adapter of another source, if one exist, to commence the communication mechanism. The adapter of another source may be a module of the system purposed for delivering information to the 3^{rd} party system, a module provided by an external service for the same purpose, or another adapter, SDK, dll, or other product designed and developed for the same purpose. 1290 represents the sending mechanism of the system, where the contacts and messages queued in 1280 are delivered via mechanisms available to the system, including but not limited to internal messaging system, private messaging systems, email, SMS, MMS, or other mechanisms. If 1290 uses instant messaging, then future communications may be sent via 2300 clipsync buddy.

1295 represents the sending mechanism called by 1285 which activates a 3^{rd} party invitation mechanism. Messages sent via 1295 and requested by 1285 are under delivery control the 3^{rd} party system and are not subject to the capabilities or limitations of the system of the invention. If 1295 uses instant messaging, then future communications may be sent via 2300 clipsync buddy. 1299 represents the completion of communications in 1200. 1300 shows a logical view of an instant messaging (IM) bridge used to obtain contacts and contact presence in the invention, where the IM bridge exists on the user's PC or computing device and interacts with a server of the system (called clipsync server) and a third party system that communicates with an instant messaging client that is also running on the user's PC or computing device.

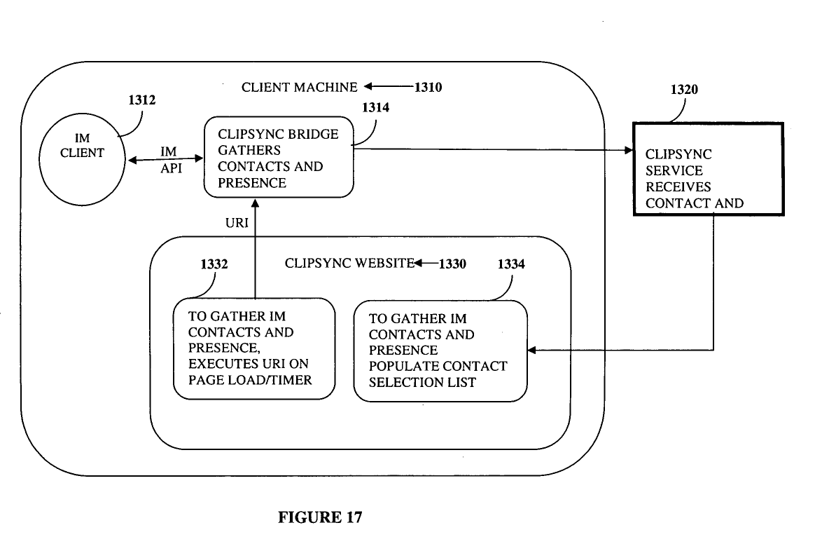

FIG. 17 exemplarily illustrates the user's machine. The user's machine is also referred to as client machine as it acts as a client in a client-server data exchange. The client machine is where most of the information is initiated and managed. 1312 represents an instant messaging client which runs on the user's PC or computing device and is usually independent of the Clipsync Bridge 1314 and clipsync website 1330. Both 1314 and 1330 may communicate with 1312 through web, instant messaging, or other protocols. In the embodiment of the invention, 1312 communicates with other components via an instant messaging API.

1314 represents a bridge or interface, called Clipsync Bridge, which interoperates with the instant messaging client 1312 and manages information to 1320 and 1330. 1314 may be a web browser, web browser plug-in, stand alone, or other application created to serve the bridge purpose. In this embodiment, 1314 is implemented as an installed application. 1320 represents a server of the system (called a clipsync server), which receives contact and contact presence info for use in invitations or for storage and use at a later time. 1330 represents the clipsync website, or the website of the invention, which is rendered in a browser in this embodiment. The local rendering of the website talks with 1314 to request and manage information requests to 1312 which are then marshaled back to 1320 which are them rendered by 1330.

1332 represents application logic, pre-rendered code, or HTML in the rendered 1330 which initiates the request to gather instant messaging contacts and presence information. 1334 represents application logic, pre-rendered code, or HTML in the rendered 1330 which is provided by 1320 that is used in rendering the contact list and presence list in the invitation mechanism of the invention. 1400 represents the invitation process using an instant messaging bridge and clipsync server. This process represents an outbound invitation process based on contact information requested in 1300.

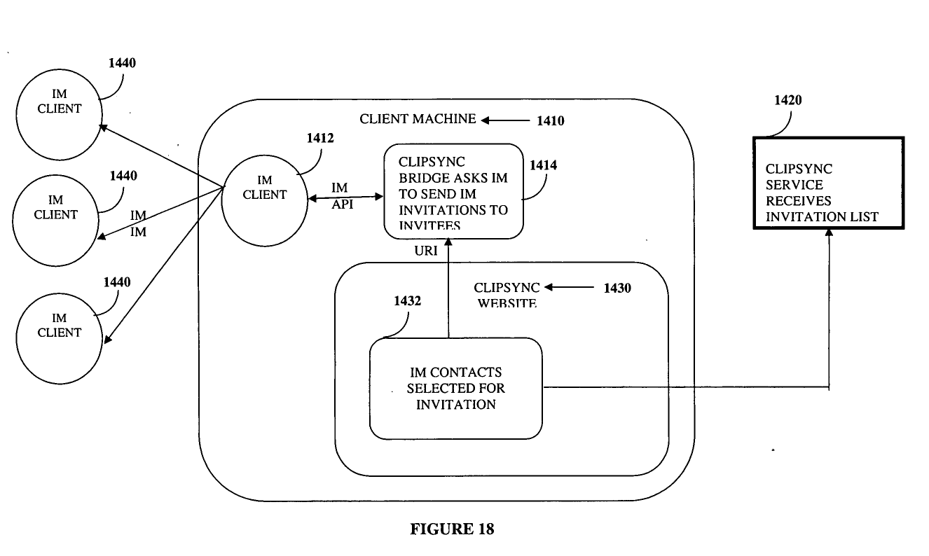

FIG. 18 exemplarily illustrates a client machine. The client machine is logically the same as 1310, where a request was made for contact and present information, and results were returned including contact information and presence information. The contact and presence information have been rendered for future action primarily for selecting one, none, all, or a subset of the contacts returned in 1300 for inviting to participate in a the current session. 1412 represents an instant messaging client application, logically the same as 1412, through which invitations will be sent. 1414 represents an instant messaging bridge, logically the same as 1314, but used for a different purpose. 1414 may represent the same bridge as 1314 or a different one, a different multi-functioned application, or an application expressly designed for the purpose of the invitation broadcast, however the function of 1414 in 1400 serves to bridge the contact selection process and the issuing of invitations through 1412. 1420 represents a server which stores and associates the contacts invited in 1400 with the user issuing the invitation and the current session where the invitation was issued. 1420 may be logically the same as 1320, an independent server for the express purpose of 1420, or a mixed function server where 1420 is one of several functions. 1430 may logically be the same as 1330. 1432 represents a locally rendered page or selection mechanism where contacts are selected and the command to invite those contacts is issued.

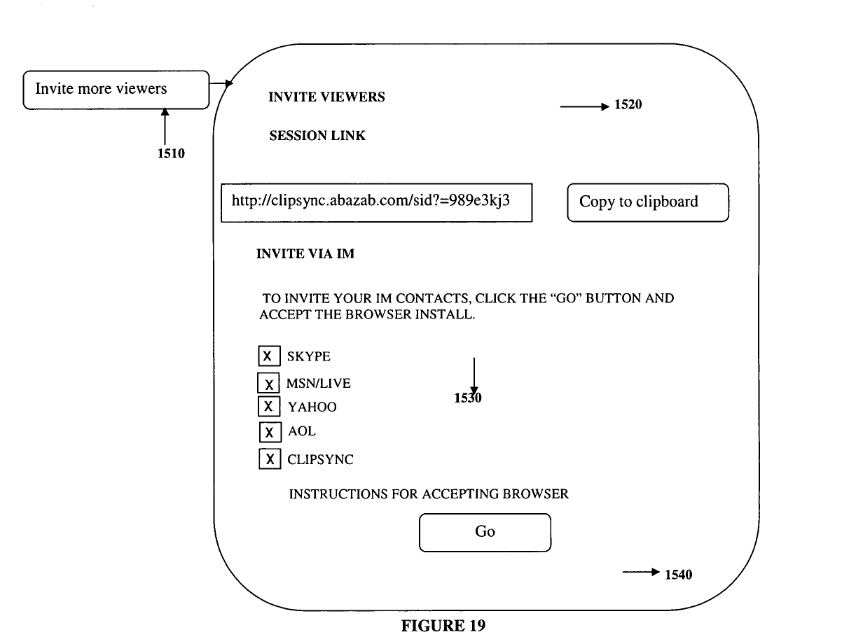

FIG. 19 exemplarily illustrates the invitation initiation process which shows the options for sending invitations via instant messages. 1510 shows that the invitation initiation is launched when an invitation link, button, or object is activated for the purpose of initiating invitations. 1520 represents the dialog, page, or window that appears or opens after the invitation link is activated showing the link to the session invitation system options 1530, and the start or go button to begin the process for setting up the invitation system. 1530 After installation of browser extension, page refreshes to show IM user list, which may be used to contact the users 301 in the displayed IM systems. In this embodiment, the communications flow is shown related to invitations. 1540 continues the process of extracting and presenting user for the purpose of inviting them to the current session or future sessions.

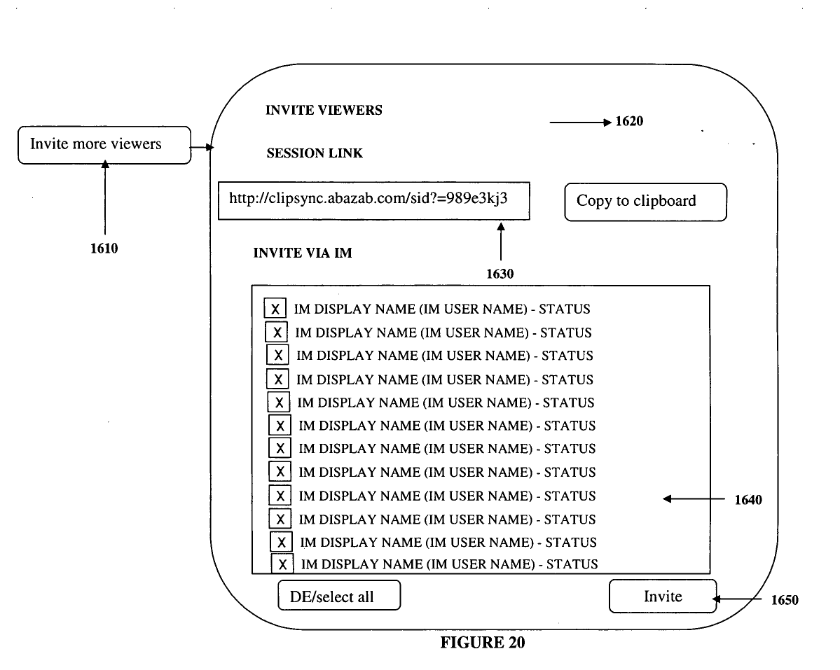

FIG. 20 exemplarily illustrates a contact display and selection overview. 1610 represents the button or link or object a user clicks or activates as part of the invitation process. 1620 represents the dialog, page, or window that is returned after a request for contacts to invite is completed in 1500. The link to the current session 1630 is shown as is a list of contacts and their online status 1640. 1630 represents link to the current session, which, when clicked on in a browser or instant messaging session will typically open a web page to the current session and launch a web browser or other application if necessary to render the session. If the user does not wish to send the link to the current session with the invitation mechanism described in the invention, he/she may copy the link to the clipboard for later use or exit.

1640 shows a list of contacts and their online status displayed by 1260 before an invitation to join the current session is sent. All contacts are displayed in the selected state and their online status or presence, if know, is also shown. The inviter can deselect all, deselect contacts one by one, or reselect contacts deselected one by one or all. Once contacts have been selected, they are added to the invite queue when invite button 1650 is pressed. 1650 represents an invite button which queues the selected contacts for invitation but does not send them. Once queued, the contact list waits for invitation message completion in the message updater 1270 before being sent.

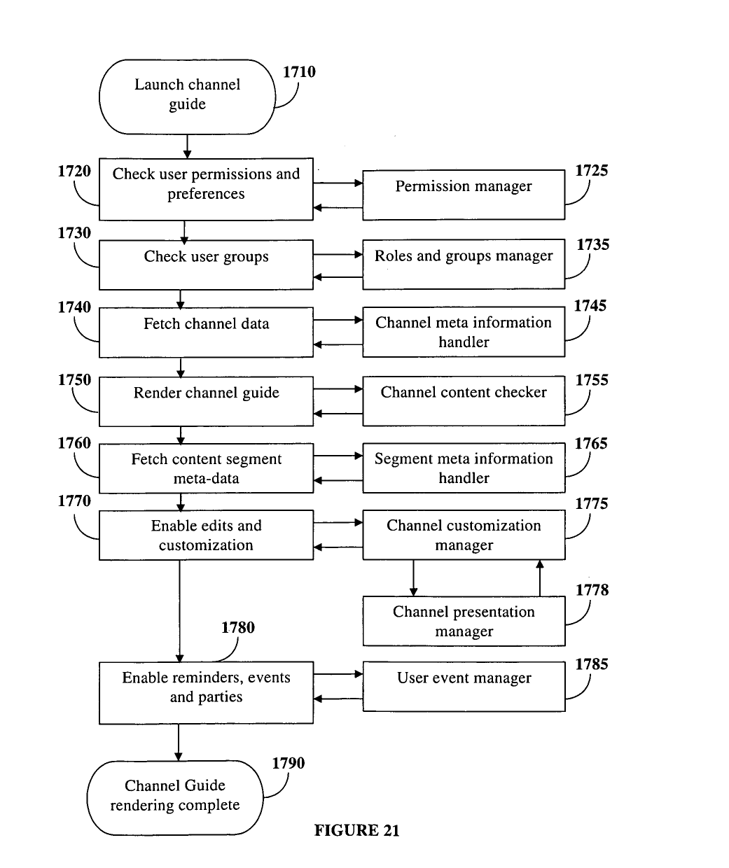

FIG. 21 exemplarily illustrates the display of a channel guide. 1710 represents the start of the channel display process, where the channel guide is launched when link, button, or other object is activated for the purpose of displaying the channel guide. 1720 represents a check step where the permission and preference for the user starting 1710 are fetched from 1725.

A channel guide, and there may be more than one, includes display properties which may be dependent or constrained by permissions and roles of the user requesting the channel guide. If the user is anonymous or not uniquely identified, the channel guide uses default permissions for display. 1730 represents a check for user groups that the user may below to and that may affect the channel guide rendering. The user group and or role of the user in a group may also affect what is displayed in the channel guide. 1735 represents a roles and groups manager that manages and store group information and history, where the users 301 may belong to none, one, or more groups simultaneously.

1740 represents a request to fetch channel data that is appropriate for the user, his/her permission, and his/her groups and roles. 1745 represents a channel meta information handler that provides and manages the channel data, which includes information about the channel and shows, where top line data is pulled on a channel basis for each and every channel necessary for rendering given the permission and page constraints. 1750 represents the rendering step, where the channel guide is rendered in a browser, browser plug-in, standalone application, mobile application, etc. 1755 represents a channel content checker which provides error checking and real-time status for 1750 beyond standard metadata, and includes indicators for online, offline, banned, age limitations, etc that might have been introduced for the channels.

1760 represents a request to fetch content segment specific meta-data, where individual shows and show data, segments, and segment data are pulled to fill in detail for the channels. 1760 pulls the information from 1765. 1765 represents an information handler that pulls show, segment, or series specific data for each channel. 1770 represents a customization step, where historical customizations or preferences may be applied, or a user may create or customize their channel guide view. Historical customizations, if allowed, are automatically applied. New customizations may be applied by clicking a “customize” type link, button, or object to activate the customization process and invoke 1775. 1775 represents a channel customization manager, where manual or programmatic filtering can be accomplished to remove individual items in one or more channel from display or programmatically exclude groups and classes of shows using factors such as age, rating, names, content type, etc.

1778 represent an optional rendering update that modifies the presentation of the channel, where the selectively removed content simply does not appear, or the user can apply settings for look, feel, navigation, etc. including the application of skins. 1780 represents an extension of the invention, where addition social aspects around the channel guide can be set, viewed, and managed. These include such things as reminders, events, parties, etc. that can be used as public or private settings for consuming content on a channel guide. 1785 represents an event manager that tracks events and the users 301 including their reminders, events, etc. 1790 represents the completion of the channel guide rendering.

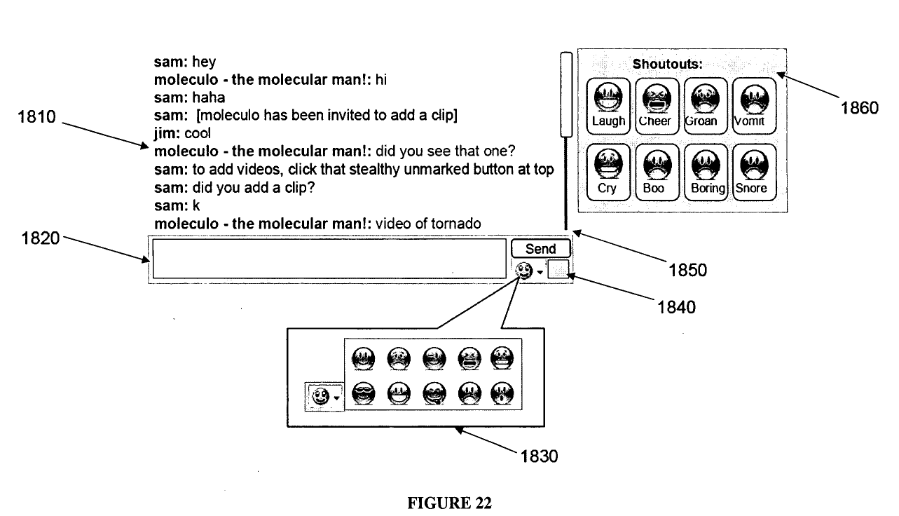

FIG. 22 exemplarily illustrates the basic components of a chat module. 1810 shows a scrolling chat window where the social context of real-time text based communications between one or more participants is displayed. As the users 301 type their conversations or comments and hit send 1850 or enter, their entries appear in the scrolling chat window. Text, emotions, or other forms of personal expression can be shown in the scrolling chat window, where customizations of font type, style, size, and other effects can be applied based on user permissions, role as host, co-host, or other roles. Additional formatting and effects may apply in the scrolling chat window context based on actions of the users 301. For example a host-may execute a moderation action such as ban or block a user, and based on settings and permissions, the moderating action may appear in the scrolling chat window. Another example would be content control status, where the user who is controlling the playback may have is name, text, or background highlighted, and, when taking actions, a corresponding color change or other effect may occur in the scrolling chat window.

1820 shows the chat input area where text and other input may be used to enter communications which appear in the scrolling chat window. Chat input displays two lines of text, with scrollbar as needed. 1830 shows emotion icons which can be selected to provide image based communication to the scrolling chat window. Clicking an emotion icon displays emoticon dialog shown. Selecting an emoticon or clicking anywhere else closes dialog. The selected emoticon appears in the chat input field (as text, if technically necessary as when images are not allowed as a configuration setting). When sent, the emoticon appears as an image in the chat history, and, if a configured, the user's image in the viewers list context can also change to the selected emoticon. 1840 shows a color picker control that determines color of chat text. Advanced configuration allows the user to change chat text, background, and or names.

1850 Sending a chat message plays a configurable “new message” sound for everyone in the current session, subject to context and permission settings for the session and the users 301. 1860 shows the shoutouts selector for enhancing the communication, where a shoutout is a pre-defined sound and or animation. Rolling over a shoutout highlights it. Clicking a shoutout shows the shoutout image or animation in text chat, plays the animation in the chat history, and plays the sound for everyone.

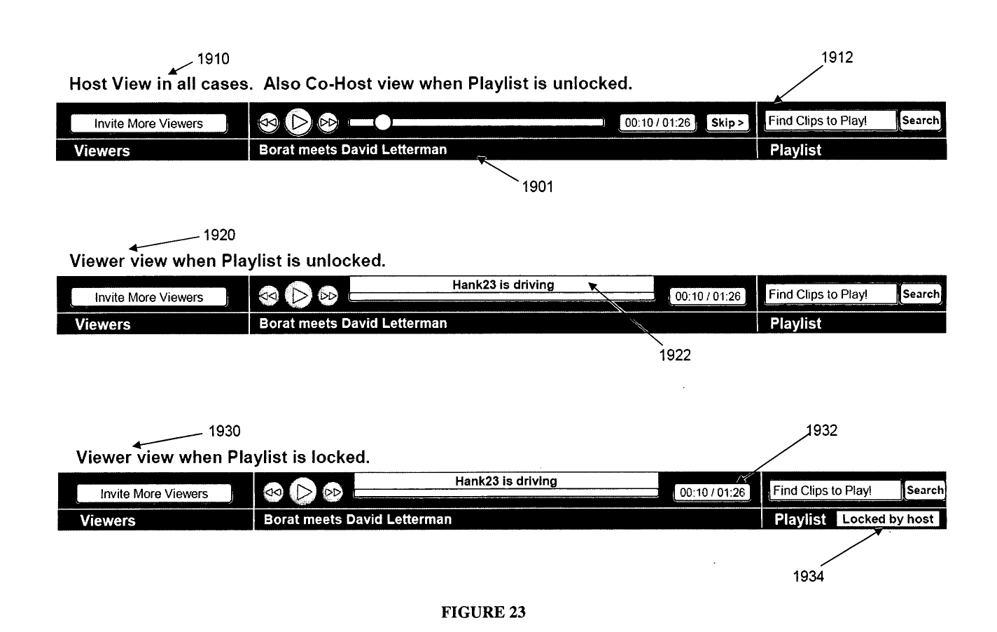

FIG. 23 exemplarily illustrates how roles impact control states for content playback. The session creator is called the “Host”, all other users 301 are “Viewers”, and Viewers with power to control or drive the current clip is called the “Co-Host”. The figure shows three different control states including host view 1910, viewer view with playlist unlocked 1920, and viewer view when playlist is locked 1930. 1901 shows the name of the current content available for playback.

The host maintains full or partial control of the content during playback. All playback controls are enabled, and the host has the ability to terminate the playback of the current content and skip 1912 ahead to the next content item in the playlist. 1912 shows the skip link, button, or other object which can be activated to advance the content to the next item in the playlist. Skip advances to next clip unless there is no content to advance to. If there is no content, then the host is prompted to search or use methods other than search to find and add content to the playlist. 1920 shows the viewer view with playlist is unlocked. The play and seek buttons are disabled, there is no scrubber grip, and the skip function has been removed.

1922 shows the name of the user who is control of playback. The term driving is used to convey that the session is being led and the viewers are on a journey or experience through content. 1930 shows the viewer view when playlist is locked. The play and seek buttons are disabled, there is no scrubber grip, and the skip function has been removed. 1934 shows the notification of locked status. Locked status prevents any user other than the host from adding content to the playlist or modifying the playlist.

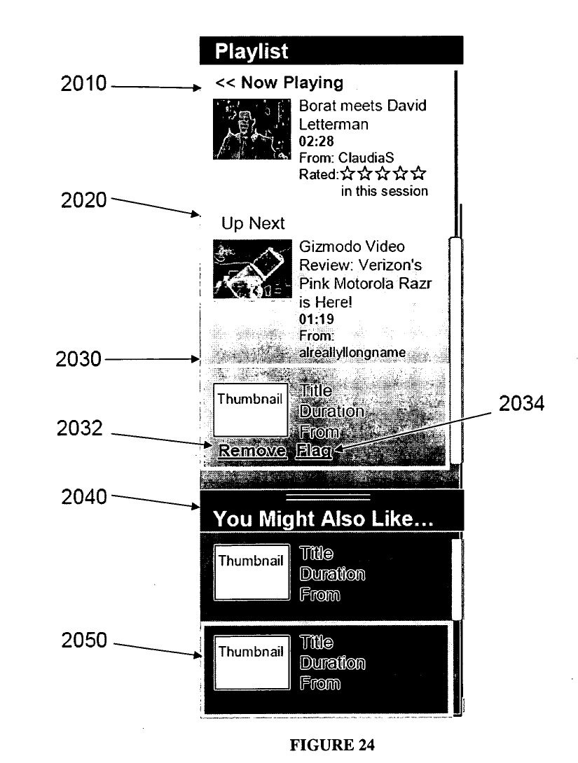

FIG. 24 exemplarily illustrates the current content clip. The current clip is marked as such and highlighted. The current content clip can be started manually, or can start automatically. Content clips automatically play (autoplay) one after another, where the next content clip to play is found below the current content clip 2010 in the playlist. The autoplay mechanism should try to keep current clip visible in the playlist to allow viewers to better understand what content is current and next. If the current content clip is visible, autoplay should scroll list to make keep current clip visible as current clip changes. If current clip is not visible, then autoplay should not scroll list when current clip changes.

2020 shows the next content clip which will play in the playlist. The next clip is marked as the next clip via text, as shown, or can be configured to indicate next clip status via color, highlight, or other behavior. 2030 shows a playlist content clip with rollover highlight in primary highlight color to indicate that the content clip can be selected and played if the user has permissions to start playback of the highlighted content clip. Clicking the content clip plays it in main video window. 2032 shows that rolling over clip displays “Remove” for the users 301 with permissions. Hosts may remove any clip. Viewers may remove any clips that they have added or have permission to drive.

2034 shows that rolling over clip displays “Flag” for everyone. Clicking allows the user to mark the content as questionable for review. Future embodiments will include detailed information assignment for flagging, including but not limited to severity of flag, type of flag, reason for flag, etc. 2040 shows a recommendation section for the current session, placed below the playlist. The recommendations can take the form of a top ten list or “You Might Also Like” recommendations which contain additional content clips presented by the system, including but not limited to manually assigned recommendations, customizable lists, context sensitive recommendations, behavior based recommendations, or commercial and sponsorship based recommendations. In a simple embodiment, the content is the top 10 list from any supported video site. 2050 shows an item in the recommendations list as highlighted. Recommendations have rollover highlights in a secondary highlight color. Clicking content clips in the recommendation list moves it to bottom of playlist above.

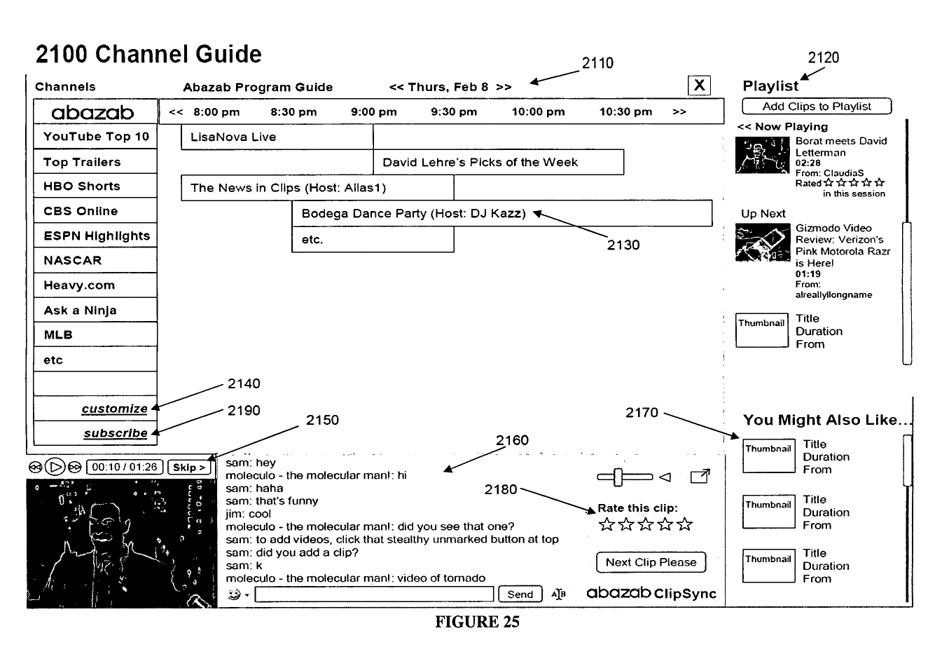

FIG. 25 exemplarily illustrates a representation of a channel guide used. The channel guide provides a context and key capabilities of sourcing and rendering channels which participants in the system may consume, subscribe, or otherwise participate in watching, managing, or interacting during playback. The channel guide view includes, but is not limited to the core channel guide 2130, a playback area 2150, a chat and personal expression area 2160, a rating area 2180, a playlist 2120, and recommendations areas 2170. 2110 shows a channel guide label, where the label may be context dependent and/or branded based on partnerships where the channel guide label can include the partner's name or logo. The channel guide label also includes relevant time and date information.

2120 shows a playlist of content, where the content displayed in 2120 may include the entire playlist content or a subset. 2130 shows scheduled programs in the channel guide, where shows may occur once, several times, or have regular appearances as in a series of shows. A show typically exists in a channel, but may, due to programming setup, appear in multiple channels automatically via a sourcing or sorting mechanism, or may be placed in a customized channel by user who creates his/her own channels or programming. 2140 represents a customize link, button, or other object that may be activated to customize the look, flow, or contents of the channel guide. Customization is based on permissions, where each channel guide may have default or non-default settings and permissions and the permissions may interact with the user's permission to allow or deny all or certain customizations.

2150 represents a playback area context where the current session's content continues playback as controlled by the session's host or co-host. 2150 operates in a smaller area, and is subject to playback controls and the roles and permissions of host, co-hosts, etc. The context 2150 is one of several simultaneous contexts ongoing during system operation. 2160 represents a chat and personal expression context area, where the chat and personal expression maintains the same operations as 1800 in whole or in part. 2170 represents a recommendations area context where recommendations for content consumption are presented to the user in the same intent and operation as 2040. The contents of 2170 may replicate the recommendations context area 2040 in whole or in part. 2180 represents a rating area where the users 301 can rate the current content. This operates the same as the rating system described in 1160 but may be presented in whole or in part.

2190 represents a link, button, or other object that may be used to activate a subscription mechanism where a user can subscribe to a channel, several channels, or subsets of channels. Subscriptions are subject to settings and permissions for channels, groups of channels or content within channels and may not be allowed at all for some channels. Subscriptions may be delivered as a channel, i.e. a channel named by the user for the content in the channel, as an email, directly into 2170 recommendations, or as an RSS feed for content. 2200 shows the message preparation flow for parameterizing communications with the users 301 in the instant messenger based social context transfer 1200. 2200 can operate independently of 1200, or may be implemented in combination with 1200. 2200 is implemented as shown to enable more atomic distribution and management of messages.

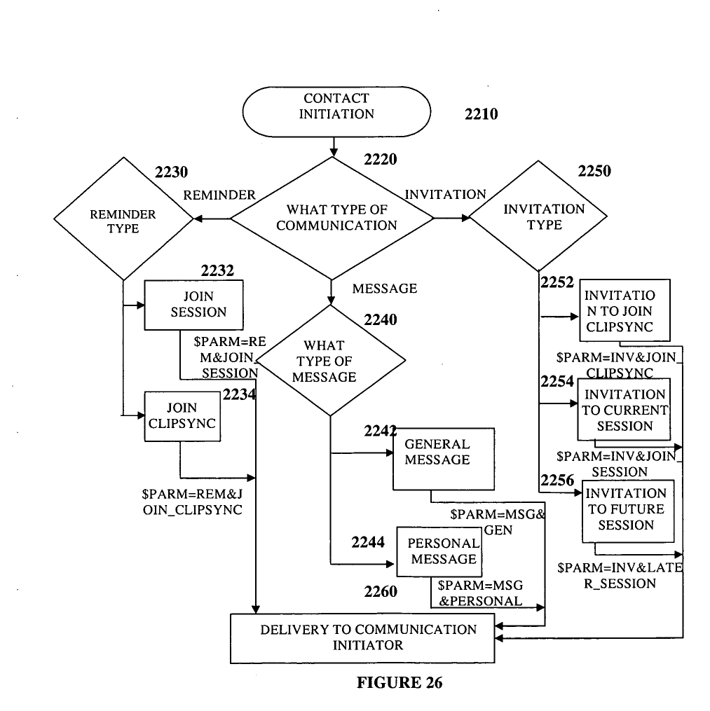

FIG. 26 exemplarily illustrates a first step in communication initiation or starting point where an “initiate contact” button, link, or object is activated or clicked. An “initiate contact” button, link, or object may take the form of an “invite more users 301” in the current session, or it may appear as a generic “initiate contact” object on a user's personal profile, or home page in the system, or elsewhere on a site or application related to the invention. In cases where the communication is automatically, programmatically, or manually scheduled, 2210 is accomplished through a trigger or timer in the system which is activated to perform the function of 2210. 2220 represents a decision point where 2200 determines what type of contact initiation is occurring, segments it, and dispatches the future actions to the appropriate sub-components. 2230 represents a reminder type of contact initiation, where the system determines what type of reminder is being prepared and sent. 2232 represents a manual or automatic reminder sent to a user to join a session. When this type of reminder is required, the system uses a parameterized structure identify the type and action. For instructional purposes in this example, the parameter is called $parm, where the parameters are shown as “rem” and “join_session”. The actual implementation may include, but is not limited to, parameters as arguments in an HTTP GET format, hidden parameters sent via HTTP POST, encrypted parameter hand-off, data in an XML communication, etc.

2234 represents a reminder similar to the form in 2232, where the manual or automatically sent reminder is designed to invite a user to join the system, or clipsync in this implementation. 2234 should be used to supplement invitations 2252, 2254, 2256, and other invitations that may use reminders. 2240 represents a message type of contact initiation, where the system determines what type of message is being prepared and sent. 2242 represents a manual or automatic general message sent to a user who may be a member of the system or a user who has not joined the system. When this type of message is selected, the system uses a parameterized structure identify the type and message. For instructional purposes in this example, the parameter is called $parm, where the parameters are shown as “msg” and “gen”. The actual implementation may include, but is not limited to, parameters as arguments in an HTTP GET format, hidden parameters sent via HTTP POST, encrypted parameter hand-off, data in an XML communication, etc.

2244 represents a message similar to the form in 2242, where the manual or automatically sent message is designed as a customizable personal message from the current user to a user in or out of the system. 2250 represents an invitation type of contact initiation, where the system determines what type of invitation is being prepared and sent. The invitations may be for real-time activities such as joining the current session or joining clipsync, or may include invitations to future activities, such as sessions. 2252 represents a manual or automatic invitation to join clipsync sent to a user who may be a member of the system or a user who has not joined the system. When this type of message is selected, the system uses a parameterized structure identify the type and message. For instructional purposes in this example, the parameter is called $parm, where the parameters are shown as “inv” and “join_clipsync”. The actual implementation may include, but is not limited to, parameters as arguments in an HTTP GET format, hidden parameters sent via HTTP POST, encrypted parameter hand-off, data in an XML communication, etc.

2254 represents an invitation similar to the form in 2252, where the manual or automatically sent invitation is designed to invite someone to join the current session and is sent to a user who may be a member of the system or a user who has not joined the system. 2256 represents a message similar to the form in 2252, where the invitation is designed to notify someone to attend a future session. 2260 represents the step where the categorization and parameterization of a contact initiation sequence has been completed, whereby a parameterized call is made to begin the communication initiation. Depending on message frequency and complexity, 2260 may allow for delivery to a single server which manages all communication using for 1200 and 2200 or multiple servers which manage smaller, more dedicated or limited functional communications.

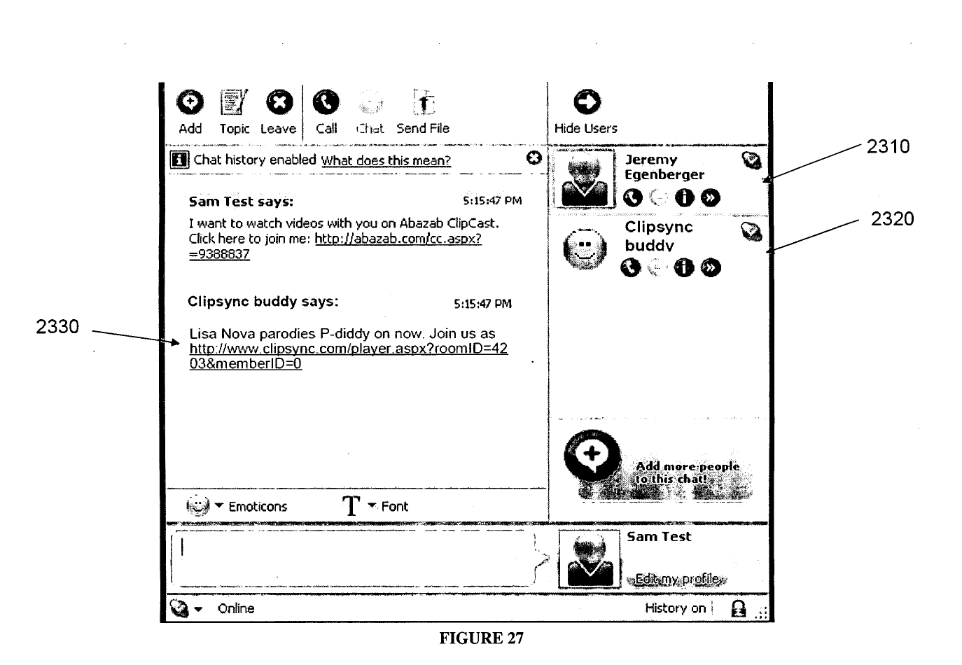

FIG. 27 exemplarily illustrates a permanent communications buddy for continued communication with users 301 with instant messaging clients. A clipsync buddy is the equivalent of a chat friend that a user adds to his or her instant messaging system. Using clipsync buddy, a user can be, depending on settings, constantly updated on events or other activities in the system of the invention. 2310 shows a standard presence indicator for a user of an instant messaging system. 2320 shows a presence indicator for a clipsync buddy in the same instant messaging system as 2310. 2330 shows a message sent through a clipsync buddy into a user's instant messaging session. The intention is that a clipsync buddy sends messages, invitation, reminders, etc. from the clipsync system to users 301 who have added a clipsync buddy friend. Depending on a user's settings in his/her instant messaging system, the clipsync buddy's messages may cause several actions including, but not limited to: notifications in the task try, set-off other notifiers, activate scripted or programmed actions of the IM client, and more.

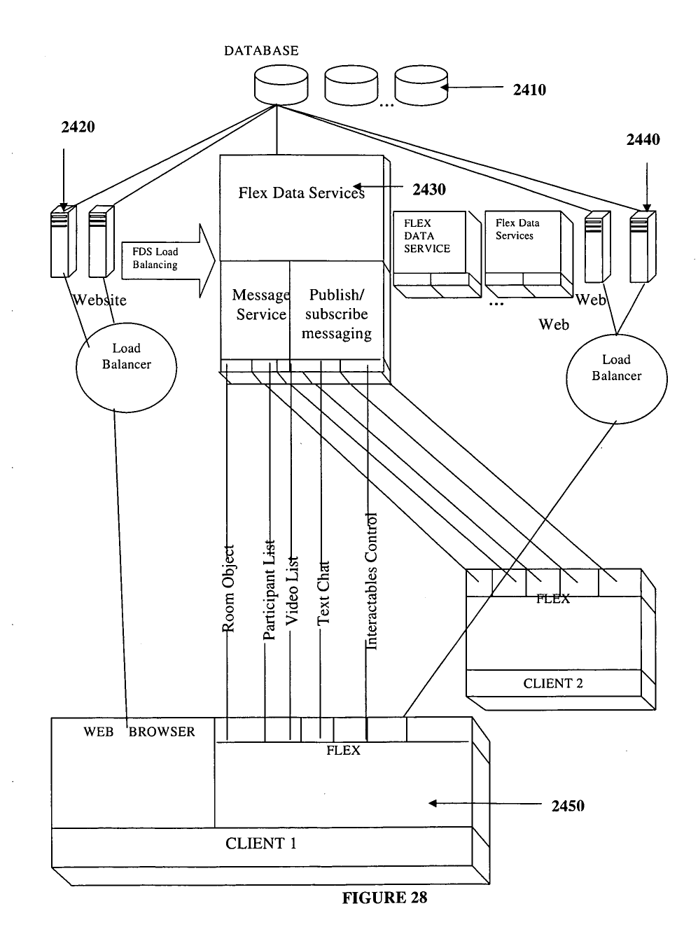

FIG. 28 exemplarily illustrates an overview of the system architecture of the virtual social environment 401. 2410 shows single, replicated, or clustered databases used to store data and procedures of the invention. Data includes, but is not limited to, user data, including metadata, user session data, reputation and history data, permissions and settings data, site data, partner data, session data, video and content data, communication and chat data, context data, room objects and interactables data. 2420 represents single, multiple, and/or load balanced web servers which provide the interfaces for sign up and friends invites, container web pages that pre-processes session requests to determine which session to load and which user may be entering the session, and determines logged in state of users 301.

2430 represents single, multiple, and/or load balanced Flex Data Services servers which serve to synchronize data between clients, so that a change on one client gets pushed out to all of the other clients, stores state information about each session in the database, passes chat messages between clients while maintaining concurrency when and where appropriate. 2440 represents single, multiple, and/or load balanced web services servers which provides correct tags for third party content playback such as YouTube video playback, provides functionality to upload user thumbnails and visual representations, provides interfaces for 3^{rd} party communications such as Skype invite functionality, and acts as a proxy server for clients connecting to the system.

2450 represents a user interface to the system, where, in this embodiment, a user's PC hosts a web browser and Flash or Flex application environment with localized applications and sub-applications, served through Flex Data Services Servers 2430, to enable communications between clients and to connect to the system. There can be one or more users 301, represented as Clients, connect to the system in a current session or across multiple sessions.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 209, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of virtual interaction between a plurality of users of a virtual social environment, comprising the steps of:
providing said virtual social environment for said users, wherein the users including a first user and a second user interact with each other in the virtual social environment;
enabling said first user to host a plurality of multimedia in the virtual social environment, wherein said step of hosting comprises one of selecting prerecorded multimedia and adding multimedia content;
inviting said second user by the first user for synchronous participation in the virtual social environment; and
enabling the first user and the second user to interact in the virtual social environment, wherein said interaction is based on a plurality of privileges assigned for the second user by the first user;
whereby said virtual interaction between the users is performed in the virtual social environment.

2. The computer implemented method of claim 1, wherein the first user creates a playlist in the virtual social environment, wherein said playlist comprises a plurality of assorted multimedia.

3. The computer implemented method of claim 1, wherein the virtual social environment enables the first user to select from a plurality of virtual interaction sessions and to join a selected virtual interaction session.

4. The computer implemented method of claim 1, wherein the virtual social environment enables the first user and the second user to search and add multimedia in the virtual social environment.

5. The computer implemented method of claim 1, wherein said privileges include allowing the second user to change user image, send invitation for others to join the session, search and add content, move the multimedia to a playlist, and modify said playlist.

6. The computer implemented method of claim 1, wherein said interaction of the first user and the second user includes online activities comprising at least one of gaming, chatting, discussions, social networking, meetings, blogging, and sharing of said multimedia.

7. The computer implemented method of claim 1, wherein the multimedia is one or more of graphical images, videos, slideshows, and audio content.

8. A computer implemented system for virtual interaction between a plurality of users of a virtual social environment, comprising:
an application server for hosting said virtual social environment, wherein said application server comprises:
a selection module for selecting one or more of a plurality of multimedia provided in the virtual social environment;
a multimedia hosting module for enabling a first user to host said selected multimedia in the virtual social environment;
an invitation module for inviting a second user by said first user for synchronous participation in the virtual social environment; and
an interaction control module for enabling the first user and said second user to interact in the virtual social environment.

9. The computer implemented system of claim 8, further wherein a multimedia acquisition module adds new multimedia content in the virtual social environment.

10. The computer implemented system of claim 8, further comprising a privilege assignment module for assigning privileges to the second user by the first user, wherein said privileges comprise allowing the second user to change user image, send invitation for others to join the session, search and add content, move the multimedia to a playlist, and modify said playlist.

11. The computer implemented system of claim 8, further comprising a creation module for creating a playlist by the first user in the virtual social environment.

12. The computer implemented system of claim 8, further comprising an information database for storing information of the first user and the second user and said multimedia.

13. The computer implemented system of claim 8, further comprising a graphical user interface for enabling the first user and the second user to access the virtual social environment.

14. A computer program product comprising computer executable instructions embodied in a computer-readable medium, wherein said computer program product comprises:
a first computer parsable program code for hosting a plurality of multimedia in a virtual social environment;
a second computer parsable program code for selecting prerecorded multimedia and adding multimedia content in said virtual social environment;
a third computer parsable program code for inviting a second user by said first user for synchronous participation in the virtual social environment; and
a fourth computer parsable program code for enabling interaction between the first user and said second user in the virtual social environment.
